(19) United States
(12) Patent Application Publication
(10) Pub. No.: US 2025/0011628 A1
(43) Pub. Date: Jan. 9, 2025

(54) RELEASE COMPOSITION, ARTICLES PREPARED FROM THE RELEASE COMPOSITION, AND RELATED METHODS

(71) Applicant: 3M INNOVATIVE PROPERTIES COMPANY, St. Paul, MN (US)

(72) Inventor: Marie A. Boulos, West St. Paul, MN (US)

(21) Appl. No.: 18/709,313

(22) PCT Filed: Nov. 15, 2022
(86) PCT No.: PCT/US2022/049955

§ 371 Date: May 13, 2024

Related U.S. Application Data
(60) Provisional application No. 63/279,866, filed on Nov. 16, 2021.

(51) Int. Cl. C09J 7/40; C09J 7/20

(52) U.S. Cl. CPC C09J 7/401; C09J 7/201; C09J 2301/208; C09J 2301/416

(57) ABSTRACT

The release composition includes a siloxane polymer having a weight average molecular weight of at least 1000 grams per mole, a first crosslinker and a second crosslinker, each crosslinker independently a compound represented by formula Si(OR⁵)₄ or R¹Si(OR⁵)₃, or a compound having at least two groups represented by formula —Si(R⁴)ₓ(OR⁵)₃₋ₓ, and a photoacid generator. The siloxane polymer includes repeating divalent units represented by formula and at least two functional groups selected from silanol, alkoxy silane, —Si(OR²)_{y}(R″)_{3-y}, and a combination thereof. In these formulas, each R is independently alkyl, each R² is independently hydrogen or alkyl, each R″ is independently alkyl or aryl, y is 1, 2, or 3, each R⁴ is independently alkyl or aryl, each R¹ and R⁵ is independently alkyl; and x is 0 or 1. An article including a cured reaction product of the release composition and a method of making the article are also described.

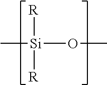

### BACKGROUND

Adhesive tape comes in many varieties, for example, single-sided or double-sided adhesive tape that is wound into a roll. Some adhesive tapes have a backing layer and an adhesive layer securely bonded to the backing layer. To facilitate unrolling of the adhesive tape, the side of the backing layer opposite the adhesive layer can have a release layer.

Some adhesive tapes are adhesive transfer tapes with an adhesive layer adjacent a release liner that protects the adhesive layer and that is removed before securely bonding the adhesive layer to a substrate. The release liner has a backing layer and a release layer on one or both surfaces of the backing layer. The release liner is positioned adjacent to the adhesive layer such that there is a release layer between the adhesive layer and the backing layer of the release liner. In some embodiments, the release liner has a second release layer that is positioned adjacent to the adhesive layer and a first release layer that is opposite the adhesive layer. The first release layer can facilitate unrolling the adhesive tape. The second release layer typically has different release properties towards the adhesive layer than the first release layer.

Release layers have been prepared by dissolving the release components in solvent, coating the resulting solution onto a surface of the backing layer, and drying to evaporate the solvent. Solvent-based processes, however, have become increasingly less desirable due to special handling requirements and environmental concerns. Release layers that can often be prepared in the absence of organic solvents are reported in Int. Pat. App. Pub. No. WO 2020/128729 (Boulos et al.). Cure-on-demand compositions including reactive silanes and acid generators are described in U.S. Pat. No. 6,204,350 (Liu et al.).

### SUMMARY

Release compositions that can be included in various adhesive tape products and in release liners for adhesive tapes are provided. Advantageously, the release layers formed from the release compositions can retain stable release characteristics over time towards the adhesive. Further, the release layers can be exposed to electron beam radiation in the process of crosslinking an adjacent adhesive layer without significantly altering the release characteristics. Still further, the release compositions advantageously include siloxane polymers having a weight average molecular weight (e.g., at least 1000 grams per mole) that can lead to reduced volatile content of the release layers (e.g., reduced volatile siloxane content).

In a first aspect, a release composition is provided that includes a siloxane polymer having a weight average molecular weight of at least 1000 grams per mole, a first crosslinker and a second crosslinker, each crosslinker is independently a compound represented by formula Si(OR⁵)₄ or R¹Si(OR⁵)₃, or a compound having at least two groups represented by formula —Si(R⁴)ₓ(OR⁵)₃₋ₓ, and a photoacid generator. The siloxane polymer includes repeating divalent units represented by formula

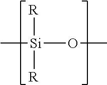

and at least two functional groups selected from the group consisting of silanol, alkoxysilane, —Si(OR²)_{y}(R″)_{3-y}, and a combination thereof. In these formulas, each R is independently alkyl, each R² is independently hydrogen or alkyl, each R″ is independently alkyl or aryl, y is 1, 2, or 3, each R⁴ is independently alkyl or aryl, each R¹ and R⁵ is independently alkyl; and x is 0 or 1.

In another aspect, the present disclosure provides a cured reaction product of the release composition.

In some embodiments, the siloxane polymer is represented by Formula (I).

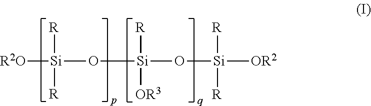

In Formula (I), R is alkyl, and R² and R³ are each independently hydrogen or alkyl. Variable p is at least 10 and variable q is in a range of 0 to 0.1(p).

In another aspect, an article is provided that includes a backing layer having a first major surface and a second major surface opposite the first major surface and a first release layer adjacent to the first major surface of the backing layer. The first release layer comprises a first cured reaction product of a first release composition, wherein the first release composition is the release composition according to the first aspect.

In another aspect, a method of making an article is provided. The method includes applying a first release composition adjacent to a first major surface of a backing layer. The first release composition is the same as described above in the first aspect. The method still further includes exposing the first release composition to ultraviolet radiation or electron beam radiation to form a first release layer.

### BRIEF DESCRIPTION OF THE DRAWINGS

FIG. 1 is a schematic of a vertical cross-section of an article having a backing layer and a release layer positioned adjacent to a first major surface of the backing layer.

FIG. 2 is a schematic of a vertical cross-section of an article having a backing layer and a release layer positioned adjacent to a first major surface and a second major surface of the backing layer.

FIG. 3 is a schematic of a vertical cross-section of an article having multiple layers and arranged in the following order: first release layer-backing layer-second release layer-adhesive layer.

FIG. 4 is a schematic of the article shown in FIG. 3 that is rolled.

FIG. 5 is a schematic of a vertical cross-section of an article having multiple layers and arranged in the following order: first release layer-backing layer-adhesive layer.

The various layers in the articles shown in the above figures are not drawn to scale and the dimensions shown in the figures are only for illustrative purposes.

### DETAILED DESCRIPTION

Release layers, various articles that contain the release layers, and methods of making the release layers and articles are provided. The release layers can be useful in various adhesive tapes and/or release liners for adhesive compositions. Advantageously, the release layers can often be prepared in the absence of organic solvents and/or using siloxane polymers having a relatively low volatile content. Further, in some advantageous embodiments, uncured adhesive layers can be cured with electron beam radiation or ultraviolet radiation while in contact with the release layers without significantly altering the release characteristics of the release layers.

The release layers contain a cured reaction product of a release composition that contains a siloxane polymer, at least a first crosslinker and a second crosslinker, and a photoacid generator. In articles of the present disclosure, the release layers are typically adjacent to at least one major surface of a backing layer. If there are two release layers (i.e., there is a release layer adjacent to a first and second major surface of the backing layer), the release layers can differ in how strongly they adhere to (i.e., how easily they can be released from) an adhesive layer. The strength of adhesion to (i.e., the case of releasing from) an adhesive layer can be varied by adding a silicate resin to the release layer or altering the amount of a silicate resin in the release layer.

Articles are provided that include a backing layer and at least one release layer adjacent to a major surface of the backing layer. In some embodiments, the articles are adhesive tapes with a release layer positioned adjacent to a first major surface of a backing layer and an adhesive layer positioned adjacent to a second major surface of the backing layer adjacent opposite the release layer. That is, the adhesive tapes have an overall construction that is an adhesive layer-backing layer-release layer. In other embodiments, the articles are release liners with two release layers. That is, the release liners can have a backing layer with a first release layer adjacent to a first major surface of the backing layer and with a second release layer adjacent to a second major surface of the backing layer. The overall construction of the release liner is first release layer-backing layer-second release layer. The release liners can be used to form transfer adhesive tapes with an adhesive layer adjacent to the release liner. That is, the overall construction of the transfer adhesive tape is an adhesive layer-first release layer-backing layer-second release layer. The adhesive layer can be a single layer or can be a first layer of a multilayer adhesive construction.

As used herein, “a”, “an”, and “the” are used interchangeably and mean one or more.

The phrases “at least one of” and “comprises at least one of” followed by a list refers to any one of the items in the list and any combination of two or more items in the list.

The term “and/or” is used to indicate that one or both stated cases may occur, for example A and/or B includes, (A and B) and (A or B). That is, it is used to mean A alone, B alone, or both A plus B.

The term “alkyl” refers to a monovalent group that is a radical of an alkane. The alkyl can have at least 1, at least 2, at least 3, at least 4, at least 6, or at least 10 carbon atoms and can have up to 32 carbon atoms, up to 24 carbon atoms, up to 20 carbon atoms, up to 18 carbon atoms, up to 12 carbon atoms, up to 10 carbon atoms, up to 6 carbon atoms, or up to 4 carbon atoms. The alkyl can be linear, branched, cyclic, or a combination thereof. A linear alkyl has at least one carbon atom while a cyclic or branched alkyl has at least 3 carbon atoms. In some embodiments, if there are greater than 12 carbon atoms, the alkyl is branched. Examples of linear alkyl groups include methyl, ethyl, n-propyl, n-butyl, n-pentyl, n-hexyl, n-heptyl, and n-octyl groups. Examples of branched alkyl groups include iso-propyl, iso-butyl, sec-butyl, t-butyl, neopentyl, iso-pentyl, and 2,2-dimethylpropyl groups. Examples of cycloalkyl groups include cyclopropyl, cyclobutyl, cyclopentyl, and cyclohexyl.

The term “alkoxy” refers to a monovalent group of formula —OR^{a} where R^{a} is an alkyl as defined above.

The term “alkylene” refers to a divalent group that is a radical of an alkane. The alkylene can have at least 2, at least 3, at least 4, at least 6, or at least 10 carbon atoms and can have up to 32 carbon atoms, up to 24 carbon atoms, up to 20 carbon atoms, up to 18 carbon atoms, up to 12 carbon atoms, up to 10 carbon atoms, up to 6 carbon atoms, or up to 4 carbon atoms. The alkylene can be linear, branched, cyclic, or a combination thereof. A linear alkylene has at least one carbon atom while a cyclic or branched alkylene has at least 3 carbon atoms. In some embodiments, if there are greater than 12 carbon atoms, the alkylene is branched. Examples of linear alkylene groups include methylene, ethylene, n-propylene, n-butylene, n-pentylene, n-hexylene, n-heptylene, and n-octylene groups. Examples of branched alkylene groups include iso-propylene, iso-butylene, sec-butylene, t-butylene, neo-pentylene, iso-pentylene, and 2,2-dimethylpropylene groups.

The term “heteroalkyl” refers to an alkyl group where at least one of the catenated carbon atoms (i.e., a carbon in the chain, more specifically a —CH₂— group in the chain) is replaced with oxy, thio, or —NH—. That is, the heteroatom is positioned between two carbon atoms.

The term “heteroalkylene” refers to an alkylene group where at least one of the catenated carbon atoms (i.e., a carbon in the chain, more specifically a —CH₂— group in the chain) is replaced with oxy, thio, or —NH—. That is, the heteroatom is positioned between two carbon atoms.

The term “aryl” refers to a monovalent group that is a radical of an aromatic carbocyclic compound. The aryl group has at least one aromatic carbocyclic ring and can have 1 to 5 optional rings that are connected to or fused to the aromatic carbocyclic ring. The additional rings can be aromatic, aliphatic, or a combination thereof. The aryl group usually has 5 to 20 carbon atoms or 6 to 10 carbon atoms. The aryl is often phenyl or diphenyl.

The term “arylene” refers to a divalent group that is a radical of an aromatic carbocyclic compound. The arylene group has at least one aromatic carbocyclic ring and can have 1 to 5 optional rings that are connected to or fused to the aromatic carbocyclic ring. The additional rings can be aromatic, aliphatic, or a combination thereof. The arylene group usually has 5 to 20 carbon atoms or 6 to 10 carbon atoms. The arylene is often phenylene or diphenylene.

The term “(meth)acrylate” refers to acrylate, methacrylate, or both.

The terms “in a range of” or “in the range of” are used interchangeably to refer to all values within the range plus the endpoints of the range.

In a first aspect, the present disclosure provides a release composition that includes a siloxane polymer having a weight average molecular weight of at least 1000 grams per mole, at least a first crosslinker and a second crosslinker, and a photoacid generator. In another aspect, the present disclosure provides a cured reaction product of such a release composition.

The siloxane polymer included in the release composition comprises repeating divalent units represented by formula:

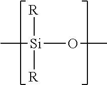

and at least two functional groups selected from the group consisting of silanol (i.e., —Si—OH), alkoxysilane (i.e., —Si—O-alkyl), —Si(OR²)_{y}(R″)_{3-y}, and a combination thereof, wherein each R is independently alkyl, each R² is independently hydrogen or alkyl, each R″ is independently alkyl or aryl, and y is 1, 2, or 3.

In some embodiments, the siloxane polymer comprises terminal units represented by formula —Q—Si(OR²)_{y}(R″)_{3-y}, divalent units represented by formula:

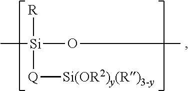

or divalent units represented by formula

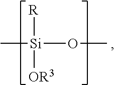

wherein each R is independently alkyl, each R² is independently hydrogen or alkyl, each R³ is independently hydrogen or alkyl, each R″ is independently alkyl or aryl, y is 1, 2, or 3, and each Q is independently alkylene, arylene, or alkylene that is at least one of interrupted or terminated by aryl, each of which is optionally at least one of interrupted or terminated by at least one ether, thioether, amine, amide, ester, thioester, carbonate, thiocarbonate, carbamate, thiocarbamate, urea, thiourea, or a combination thereof.

Suitable alkyl groups for the alkoxysilane, R, R″, R², and R³ often have 1 to 10 carbon atoms, 1 to 6 carbon atoms, 1 to 4 carbon atoms, or 1 to 3 carbon atoms. In many embodiments, R is methyl and R″, R², and R³ each have 1 to 4 carbon atoms or 1 to 3 carbon atoms. In some examples, R″, R², and R³ are independently methyl or ethyl. Suitable aryl groups for R″ often have 6 to 12 carbon atoms or 6 to 10 carbon atoms. The aryl is often phenyl. In some embodiments, y is 3. Q is independently alkylene, arylene, or alkylene that is at least one of interrupted or terminated by aryl, wherein the alkylene, arylene, and alkylene that is at least one of interrupted or terminated by aryl are optionally at least one of interrupted or terminated by at least one ether (i.e., —O—), thioether (i.e., —S—), amine (i.e., —NR¹⁶—), amide (i.e., —N(R¹⁶)—C(O)— or —C(O)—N(R¹⁶)—), ester (i.e., —O—C(O)— or —C(O)—O—), thioester (i.e., —S—C(O)— or —C(O)—S—), carbonate (i.e., —O—C(O)—O—), thiocarbonate (i.e., —S—C(O)—O— or —O—C(O)—S—), carbamate (i.e., —(R¹⁶)N—C(O)—O— or —O—C(O)—N(R¹⁶)—, thiocarbamate (i.e., —N(R¹⁶)—C(O)—S— or —S—C(O)—N(R¹⁶)—, urea (i.e., —(R¹⁶)N—C(O)—N(R¹⁶)—), thiourea (i.e., —(R¹⁶)N—C(S)—N(R¹⁶)). In any of these groups that include an R¹⁶, R¹⁶ is hydrogen, alkyl, aryl, or arylalkylenyl, wherein aryl and arylalkylenyl are unsubstiuted or substituted by at least one alkyl, alkoxy, or combination thereof. In some embodiments, R¹⁶ is hydrogen or alkyl, for example, having 1 to 4 carbon atoms (e.g., methyl, ethyl, n-propyl, isopropyl, n-butyl, isobutyl, or sec-butyl). In some embodiments, R¹⁶ is methyl or hydrogen. The phrase “interrupted by at least one functional group” refers to having part of the alkylene, arylalkylene, or alkylarylene group on either side of the functional group. An example of an alkylene interrupted by an ether is —CH₂—CH₂—O—CH₂—CH₂—. Similarly, an alkylene that is interrupted by arylene has part of the alkylene on either side of the arylene (e.g., —CH₂—CH₂—C₆H₄—CH₂—). In some embodiments, each Q is independently alkylene that is optionally at least one of interrupted or terminated by at least one ether, thioether, or combination thereof. The alkylene can have 1 to 10, 1 to 6, or 1 to 4 carbon atoms. In some embodiments. Q is alkylene having I to 10. 1 to 6, 1 to 4. 1 to 3. or 1 to 2 carbon atoms. In some embodiments, Q is a poly(alkylene oxide) group. Suitable poly(alkylene oxide) groups include those represented by formula (OR¹⁷)_{a′}, in which each OR¹⁷ is independently —CH₂CH₂O—, —CH(CH₃)CH₂O—, —CH₂CH₂CH₂O—, —CH₂CH(CH₃)O—, —CH₂CH₂CH₂CH₂O—, —CH(CH₂CH₃)CH₂O—, —CH₂CH(CH₂CH₃)O—, and —CH₂C(CH₃)₂O—. In some embodiments, each OR¹⁷ independently represents —CH₂CH₂O—, —CH(CH₃)CH₂O— or —CH₂CH(CH₃)O—. Each a′ is independently a value from 5 to 300 (in some embodiments, from 10 to about 250, or from 20 to about 200).

In some embodiments, the siloxane polymer in the release composition of the present disclosure comprises a terminal unit represented by formula —Q—Si(OR²)_{y}(R″)_{3-y}, wherein Q, R², R″, and y are as defined above in any of their embodiments. For terminal —Q—Si(OR²)_{y}(R″)_{3-y} groups, Q may also be a bond. In some embodiments, the siloxane polymer includes one terminal unit represented by formula —Q—Si(OR²)_{y}(R″)_{3-y}. In some embodiments, the siloxane polymer includes two terminal units represented by formula —Q—Si(OR²)_{y}(R″)_{3-y}. If the siloxane polymer is branched, it can include more than two terminal units represented by formula —Q—Si(OR²)_{y}(R″)_{3-y}. In some embodiments, the siloxane polymer includes at least one terminal unit represented by formula —Q—Si(OR²)_{y}(R″)_{3-y}.

The siloxane polymer in the release composition of the present disclosure is typically free of epoxide, vinyl ether, and olefinic groups including acryloxy and methacryloxy groups. In some embodiments, the release composition is free of epoxide, vinyl ether, and olefinic groups including acryloxy and methacryloxy groups. In some embodiments, the release composition is free of basic catalysts (e.g., sodium hydroxide, potassium hydroxide, lithium hydroxide, sodium methoxide, lithium methoxide, potassium methoxide, potassium tertiary butoxide, and sodium silanolate). In some embodiments, the release composition is free of amino groups.

In some embodiments, the siloxane polymer included in the release composition is represented by Formula (I).

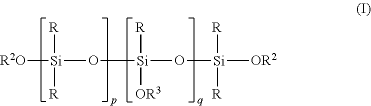

In Formula (I), each R is independently alkyl, and R² and R³ are each independently hydrogen or alkyl. Variable p is a value of at least 10, and q is a value in a range of 0 to 0.1(p).

Suitable alkyl groups for R, R², and R³ often have 1 to 10 carbon atoms, 1 to 6 carbon atoms, 1 to 4 carbon atoms, or 1 to 3 carbon atoms. In many embodiments, R is methyl and both R² and R³ have 1 to 4 carbon atoms or 1 to 3 carbon atoms. In some examples, R² and R³ are independently methyl or ethyl.

The variable p in Formula (I) is equal to at least 10. The upper limit of p can be up to 7000 or even higher. For example, p can be at least 12, at least 13, at least 14, at least 15, at least 20, at least 30,at least 40, at least 50, at least 80, at least 100, at least 200, at least 300, at least 500, or at least 1000 and up to 7000, up to 6000, up to 5000, up to 4000, up to 3000, or up to 2000, up to 1000, up to 500, up to 300, up to 200, up to 100, or up to 50. The siloxane polymer is often a mixture of various compounds having different molecular weights. If p is too low, the resulting release layer may have an unacceptable volatile content (i.e., an unacceptable amount of volatile siloxane compounds such as D3-D6 cyclic siloxane compounds may be included in the siloxane polymer). That is, if the siloxane polymer is not completely cured, the siloxane polymer (or low molecular weight compounds included in a siloxane polymer) may be volatile under certain process conditions used in preparing the release layer, which may be undesirable. On the other hand, if p is too large, the siloxane polymer may have a viscosity that is too high to be used without dilution by an organic solvent. While using organic solvents may be acceptable for some applications, they may be undesirable for other applications where low volatile content is desired.

In some embodiments of Formula I, the siloxane polymer has two alkoxy groups of formula —OR² at the terminal positions. In some of these embodiments, q is equal to zero. In some embodiments, there are additional alkoxy groups along the polymeric chain. In such polymers, q has a value up to 0.1(p). As the molecular weight of the polymer increases, the value of q can increase. The variable q is often no greater than 700, no greater than 600, no greater than 400, no greater than 200, no greater than 100, no greater than 50, no greater than 20, no greater than 10, or no greater than 5. In some embodiments, the variable q is in a range of 0 to 100, 1 to 100, 0 to 50, 1 to 50, 0 to 20, 1 to 20, 0 to 10, 1 to 10, 0 to 5, or 1 to 5. Where q is at least 1, the siloxane polymer can be a random or block copolymer.

The weight average molecular weight (Mw) of the siloxane polymer can be in a range of 1000 to 500,000 grams per mole (g/mol). The weight average molecular weight can be at least 1500 g/mol, at least 2000 g/mol, at least 2500 g/mol, at least 3000 g/mol, at least 4000 g/mol, at least 5000 g/mol, or at least 10,000 g/mol and up to 500,000 g/mol, up to 200,000 g/mol, up to 100,000 g/mol, up to 50,000 g/mol, up to 40,000 g/mol, up to 30,000 g/mol, up to 20,000 g/mol, up to 10,000 g/mol, or up to 5,000 g/mol. If it is desirable to avoid the use of organic solvents to decrease the viscosity of the release composition and/or to minimize the volatile content, the weight average molecular weight of the siloxane polymer is often selected to be no greater than 50,000 g/mol. The weight average molecular weight can be determined using gel permeation chromatography (GPC).

In some embodiments, the release composition contains at least 20 weight percent of the siloxane polymer as described above in any of its embodiments, based on the total weight of the release composition. The amount can be, for example, at least 25 weight percent, at least 30 weight percent, at least 35 weight percent, at least 40 weight percent, at least 45 weight percent, at least 50 weight percent, at least 55 weight percent, or at least 60 weight percent and can be up to 95 weight percent, up to 90 weight percent, up to 85 weight percent, up to 80 weight percent, or up to 75 weight percent. For example, the amount of the siloxane polymer can be in a range of 20 to 95 weight percent, 20 to 90 weight percent, 20 to 85 weight percent, 30 to 85 weight percent, 40 to 85 weight percent, 50 to 85 weight percent, 60 to 85 weight percent, or 60 to 80 weight percent based on the total weight of the release composition.

A combination of two or more siloxane polymers each independently having a weight average molecular weight of at least 1000 grams per mole may be useful in the release composition of the present disclosure. Each of the siloxane polymers may be as described above in any of its embodiments. In some embodiments, the release composition comprises a siloxane polymer having at least two silanol groups in combination with a siloxane polymer having at least two alkoxysilane groups. In some embodiments, the release composition comprises a siloxane polymer represented by Formula I in which each R² is hydrogen in combination with a siloxane polymer represented by Formula I in which each R² is alkyl.

The release composition further includes at least a first crosslinker and a second crosslinker. Each of the first crosslinker or the second crosslinker is independently a compound represented by formula Si(OR⁵)₄ or R¹Si(OR⁵)₃ or a compound having at least two silyl groups represented by formula —Si(R⁴)ₓ(OR⁵)₃₋ₓ where R⁴ is alkyl or aryl, each of R¹ and R⁵ is independently alkyl, and x is 0 or 1. Suitable alkyl groups for R¹, R⁴, and R⁵ often have 1 to 10 carbon atoms, 1 to 6 carbon atoms, 1 to 4 carbon atoms, 1 to 3 carbon atoms, or 1 to 2 carbon atoms. Suitable aryl groups for R⁴ often have 6 to 12 carbon atoms or 6 to 10 carbon atoms. The aryl is often phenyl. Each silyl group can react with at least two, three, or four other alkoxy and/or hydroxy groups such as alkoxy and/or hydroxy groups on the siloxane polymer described above in any of its embodiments. Reacting more than two alkoxy groups of the crosslinker results in crosslinking rather than chain extension.

In some embodiments, at least one of the first or second crosslinker is represented by formula Si(OR⁵)₄. Examples of such crosslinkers include tetramethoxysilane, tetraethoxysilane, and tetrapropoxysilane.

In some embodiments, at least one of the first or second the crosslinker is represented by formula R¹Si(OR⁵)₃. Examples of such crosslinkers include ethyltriethoxysilane and propyltrimethoxysilane.

In some embodiments, at least one of the first or second the crosslinker is represented by formula (II). In some embodiments, each of the first and second crosslinker is independently represented by formula (II).

(OR⁵)₃₋ₓ(R⁴)ₓSi—R⁸—Si(R⁴)ₓ(OR⁵)₃₋ₓ (II)

In Formula (II), R⁸ is oxy, a group represented by formula —O—[Si(CH₃)₂—O]ₘ—, an alkylene, an alkylene—Si(CH₃)₂—O—Si(CH₃)₂-alkylene, a heteroalkylene, a heteroalkylene, a heteroalkylene substituted with a hydroxyl group, an arylene, a fluorine substituted arylene, or an alkylene-arylene-alkylene group. In some embodiments, R⁸ is oxy or alkylene. The variable m is an integer in a range of 1 to 10. R⁴, R⁵, and variable x are the same as described above. If x is equal to 0, then Formula (II) can be written as Formula (II-A).

(OR⁵)₃Si—R⁸—Si(OR⁵)₃ (II-A)

If x is equal to 1, then Formula (II) can be written as Formula (II-B).

(OR⁵)₂(R⁴)Si—R⁸—Si(R⁴)(OR⁵)₂ (II-B)

If group R⁸ in Formula (II) is oxy, then the crosslinker can be written as Formula (II-1).

(OR⁵)₃₋ₓ(R⁴)ₓSi—O—Si(R⁴)ₓ(OR⁵)₃₋ₓ (II-1)

Examples of such crosslinkers include (CH₃CH₂O)₃Si—O—Si(OCH₂CH₃)₃, (CH₃O)₃Si—O—Si(OCH₃)₃, (CH₃CH₂O)₂(CH₃)Si—O—Si(CH₃)(OCH₂CH₃)₂, and (CH₃O)₂(CH₃)Si—O—Si(CH₃)(OCH₃)₂.

If group R⁸ in Formula (II) is an alkylene, the alkylene often has 1 to 12 carbon atoms, 1 to 10 carbon atoms, 1 to 6 carbon atoms, 1 to 4 carbon atoms, or 1 to 3 carbon atoms. Examples include (CH₃CH₂O)₃Si—C₂H₄—Si(OCH₂CH₃)₃, (CH₃CH₂O)₂(CH₃)Si—C₂H₄—Si(CH₃)(OCH₂CH₃)₂, (CH₃O)₃Si—C₂H₄—Si(OCH₃)₃, (CH₃O)₂(CH₃)Si—C₂H₄—Si(CH₃)(OCH₃)₂, (CH₃CH₂O)₃Si—C₄H₈—Si(OCH₂CH₃)₃, (CH₃CH₂O)₃Si—C₆H₁₂—Si(OCH₂CH₃)₃, (CH₃CH₂O)₃Si—C₈H₁₆—Si(OCH₂CH₃)₃, (CH₃CH₂O)₂(CH₃)Si—C₈H₁₆—Si(OCH₂CH₃)₂(CH₃), and (CH₃CH₂O)₃Si—C₁₀H₂₀—Si(OCH₂CH₃)₃. The two silyl groups do not need to be in the terminal positions of the alkylene but can be on any carbon atom such as in 1,2-bis(trimethoxysilyl)decane or even on the same carbon atoms such as in bis(trimethoxysilyl)methane ((CH₃O)₃Si—CH₂—Si(OCH₃)₃) and bis(tricthoxysilyl)methane ((CH₃CH₂O)₃Si—CH₂—Si(OCH₂CH₃)₃).

If group R⁸ in Formula (II) is alkylene—Si(CH₃)₂—O—Si(CH₃)₂-alkylene, each alkylene can independently have 1 to 12 carbon atoms, 1 to 10 carbon atoms, 1 to 6 carbon atoms, 1 to 4 carbon atoms, or 1 to 3 carbon atoms. Examples include 1,3-bis(triethoxysilylethyl)tetramethyldisiloxane ((CH₃CH₂O)₃—CH₂CH₂—Si(CH₃)₂—O—Si(CH₃)₂—CH₂CH₂—Si(OCH₂CH₃)₃).

If group R⁸ in Formula (II) is a heteroalkylene or a heteroalkylene substituted with a hydroxyl group, the heteroalkylene often has one or more heteroatoms selected from —S—, —O—, or —NH—. In some examples, there can be 1 to 5 heteroatoms, 1 to 3 heteroatoms, or 1 to 2 heteroatoms and 2 to 20 carbon atoms, 2 to 16 carbon atoms, 2 to 12 carbon atoms, 2 to 10 carbon atoms, or 2 to 6 carbon atoms. Examples include bis[3-(trimethoxysilyl)propyl]amine and 1,11-bis(trimethoxysilyl)-4-oxa-8-azaundecan-6-ol.

If group R⁸ in Formula (II) is an arylene, the arylene often has 6 to 12 carbon atoms. The arylene optionally can be substituted with one or more fluorine atoms. In some embodiments, the arylene is phenylene or diphenylene. The fluorinated arylene is often phenylene substituted with 1 to 4 fluorine atoms (e.g., tetrafluorophenylenc). The groups —Si(R⁴)ₓ(OR⁵)₃₋ₓ can be positioned in an ortho, meta, or para positions relative to each other on the same aromatic ring or on different aromatic rings. Examples include, but are not limited to, (CH₃CH₂O)₃Si—C₆H₄—Si(OCH₂CH₃)₃, (CH₃CH₂O)₂(CH₃)Si—C₆H₄—Si(CH₃)(OCH₂CH₃)₂, (CH₃CH₂O)₃Si—C₆H₄—C₆H₄—Si(OCH₂CH₃)₃, (CH₃CH₂O)₂(CH₃)Si—C₆H₄—C₆H₄—Si(CH₃)(OCH₂CH₃)₂, 1,4-bis(triethoxysilyl)tetrafluorobenzene, 1,4bis(trimethoxysilyl)tetrafluorobenzene, and 1,4 bis(tricthoxysilyl)-2,3-difluorobenzene.

If group R⁸ in Formula (II) is an alkylene-arylene-alkylene group, each alkylene often contains 1 to 10 carbon atoms, 1 to 6 carbon atoms, 1 to 4 carbon atoms, or 1 to 3 carbon atoms and each arylene group often contains 6 to 12 carbon atoms. The arylene is often phenylene. Examples include, but are not limited to, 1,4-bis(trimethoxysilylmethyl)benzene and 1,4-bis(tricthoxysilylethyl)benzene.

If group R⁸ in Formula (II) is a group of formula —O—[Si(CH₃)₂—O]ₘ—, the variable m is in a range of 1 to 10, 1 to 6, to 1 to 4, or 1 to 2. In many examples, m is equal to 1 such as in example crosslinkers (CH₃CH₂O)₃Si—O—Si(CH₃)₂—O—Si(OCH₂CH₃)₃, (CH₃CH₂O)₂(CH₃)Si—O—Si(CH₃)₂—O—Si(CH₃)(OCH₂CH₃)₂, (CH₃O)₃Si—O—Si(CH₃)₂—O—Si(OCH₃)₃, and (CH₃O)₂(CH₃)Si—O—Si(CH₃)₂—O—Si(CH₃)(OCH₃)₂.

In some embodiments in which the first and second crosslinker are each independently represented by formula (OR⁵)₃₋ₓ(R⁴)ₓSi—R⁸—Si(R⁴)ₓ(OR⁵)₃₋ₓ, for at least one of the first or second crosslinker, R₈ is oxy, a group of formula —O—[Si(CH₃)₂—O]ₘ—, an alkylene, or an alkylene—Si(CH₃)₂—O—Si(CH₃)₂-alkylene, wherein each alkylene independently has up to 4, 3, 2, or 1 carbon atoms. In some embodiments in which the first and second crosslinker are each independently represented by formula (OR⁵)₃₋ₓ(R⁴)ₓSi—R⁸—Si(R⁴)ₓ(OR⁵)₃₋ₓ, for at least one of the first or second crosslinker. R₈ is oxy or an alkylene having up to 4, 3, 2, or 1 carbon atoms. In some of these embodiments, a first crosslinker is represented by formula (OR⁵)₃₋ₓ(R⁴)ₓSi—R⁸—Si(R⁴)ₓ(OR⁵)₃₋ₓ, in which R⁸ is alkylene having 5 to 12 or 6 to 10 carbon atoms, and a second crosslinker is represented by formula (OR⁵)₃₋ₓ(R⁴)ₓSi—R⁸—Si(R⁴)ₓ(OR⁵)₃₋ₓ, in which R⁸ is oxy or alkylene having 1 to 4 or 1 to 3 carbon atoms. In some embodiments, the first crosslinker is represented by formula (OR⁵)₃₋ₓ(R⁴)ₓSi—R⁸—Si(R⁴)ₓ(OR⁵)₃₋ₓ, and the second crosslinker is represented by formula Si(OR⁵)₄. In some embodiments, at least one of the first crosslinker or the second crosslinker has a molecular weight of up to 750 g/mol or up to 500 g/mol. In some of these embodiments, the first and second crosslinker may more readily dissolve the siloxane polymer and the photoacid generator in the release composition.

In some embodiments, the release composition contains at least 1 percent combined weight of the first and second crosslinker based on the total weight of the release composition. If less is used, the composition may not cure sufficiently or may cure too slowly when exposed to ultraviolet radiation. The amount of the combined first and second crosslinker can be up to 35 weight percent based on the total weight of the release composition. If more is used, the release layer may not release readily from an adhesive composition positioned adjacent to the release layer. That is, an adhesive layer may adhere too strongly to the release layer. The amount of combined first and second crosslinker can be at least 2 weight percent, at least 3 weight percent, at least 5 weight percent, at least 8 weight percent, or at least 10 weight percent and up to 35 weight percent, up to 30 weight percent, up to 25 weight percent, up to 20 weight percent, up to 15 weight percent, up to 13 weight percent, up to 12 weight percent, up to 10 weight percent, or up to 5 weight percent. In some embodiments, the release composition contains 1 to 30 weight percent, 1 to 25 weight percent, 1 to 20 weight percent, 1 to 15 weight percent, 5 to 25, 5 to 20 weight percent, 5 to 15 weight percent, 8 to 20 weight percent, 8 to 15 weight percent, 10 to 25 weight percent, or 10 to 20 weight percent of the first and second crosslinker combined based on the total weight of the release composition.

The combination of first and second crosslinkers can be useful for minimizing the haze of the release composition without the use of an organic solvent (or with the use of a decreased amount of the organic solvent). That is, the combination of first and second crosslinkers can facilitate the formation of a single-phase release composition without the addition of an organic solvent (or with the use of a decreased amount of the organic solvent). The haze and undesirable second phase are often due to incomplete dissolution of the photoacid generator in the release composition. The combination of first and second crosslinkers typically can effectively facilitate dissolution of the photoacid generator in the release composition, particularly for release compositions that contain siloxane polymers having a weight average molecular weight that is at least 1000 g/mol.

As used herein, the term “organic solvent” refers to a compound that is added to lower the viscosity of the release composition but that does not react with the other components. Like an organic solvent, at least one of the first or second crosslinker can lower the viscosity of the release composition. but it reacts with other components in the composition. By reacting, a crosslinker is less prone than an organic solvent to contribute to the volatile content of the final cured release layer. Thus, both the use of a siloxane polymer with a weight average molecular weight of at least 1000 g/mol in combination with first and second crosslinkers that are reactive with other components of the release composition contributes to an overall reduction in volatile content of the resulting release layers.

In some embodiments, the release composition includes less than one percent by weight, based on the total weight of the release composition, of a silane additive having two silyl groups of formula —Si(R⁶)₂(OR⁷) or a single silyl group of formula —Si(R¹⁰)(OR⁹)₂ where R⁶ is alkyl or aryl, R⁷ is alkyl, R⁹ is alkyl, and R¹⁰ is alkyl or aryl. Since such silane additives can react with up to two other alkoxy and/or hydroxy groups, they would contribute to chain extension of the siloxane polymer and typically would not contribute significantly to the crosslinking of the siloxane polymer. Alkyl groups for R⁶, R⁷, R⁹, and R¹⁰ often have 1 to 10 carbon atoms, and aryl groups for R⁶ and R¹⁰ have 6 to 12 carbon atoms (e.g., phenyl).

Such silane additives can more particularly be represented by Formula (III) or Formula (IV).

(R⁷O)(R⁶)₂Si—R¹¹—Si(R⁶)₂(OR⁷) (III)

R¹²—Si(R¹⁰)(OR⁹)₂ (IV)

In Formula (III), group R¹¹ is oxy, a group of formula —O—[Si(CH₃)₂—O]ₙ—, an alkylene, an arylene, a fluorinated arylene, or a alkylene-arylene-alkylene group, wherein alklyene, arylene, fluorinated arylene, or alkylene-arylene-alkylene are as defined above in connection with Formula (II). The variable n is an integer in a range of 1 to 10. If R¹¹ in Formula (III) is an oxy, then the silane additive is of Formula (III-1).

(R⁷O)(R⁶)₂Si—O—Si(R⁶)₂(OR⁷) (III-1)

In Formula (IV), R¹² is alkyl, aryl, or a group of formula —R¹³—Si(R¹⁴)₃, where R¹³ is alkylene and each R¹⁴ is independently alkyl. Alkyl groups for R¹² often have 1 to 10 carbon atoms, aryl groups typically have 6 to 12 carbon atoms (e.g., phenyl), and alkylene is as defined above in connection with Formula (II). Examples of such silane additives include (CH₂CH₃O)(CH₃)₂Si—O—Si(CH₃)₂(OCH₂CH₃), (CH₃O)(CH₃)₂Si—O—Si(CH₃)₂(OCH₃), (CH₂CH₃O)(CH₃)₂Si—CH₂CH₂—Si(CH₃)₂(OCH₂CH₃), (CH₃O)(CH₃)₂Si—CH₂CH₂—Si(CH₃)₂(OCH₃), (CH₃CH₂O)(CH₃)₂Si—C₆H₄—Si(CH₃)₂(OCH₂CH₃), (CH₃CH₂O)(CH₃)₂Si—C₆F₄—Si(CH₃)₂(OCH₂CH₃), (CH₃O)(CH₃)₂Si—C₆H₄—Si(CH₃)₂(OCH₃), (CH₃O)(CH₃)₂Si—C₆F₄—Si(CH₃)₂(OCH₃), bis(ethoxydimethylsilyl)-1,4-diethylbenzene, (CH₃O)(CH₃)₂Si—O—Si(CH₃)₂—O—Si(CH₃)₂(OCH₃), (CH₃CH₂O)(CH₃)₂Si—O—Si(CH₃)₂—O—Si(CH₃)₂(OCH₂CH₃), dimethyldiethoxysilane, dimethyldimethoxysilane, methylphenyldimethoxysilane, diphenyldimethoxysilane, (1-triethylsilyl-2-diethoxymethylsilyl)ethane, and (1-triethylsilyl-2-dimethoxymethylsilyl)ethane.

In some embodiments, the release composition includes up to or less than 0.5, 0.1, or 0.05 weight percent, based on the total weight of the release composition, of the silane additive having two silyl groups of formula —Si(R⁶)₂(OR⁷) or a single silyl group of formula —Si(R¹⁰)(OR⁹)₂. In some embodiments. the release composition is free of such silane additives, including any of those described above.

As shown in the Examples below, a comparison of a release composition including first and second crosslinkers provides a cured composition with at least one of lower extractables or a lower initial release force than a composition including a crosslinker and a chain extender represented by Formula III-1. See, for example, Examples 1 to 6 vs. Comparative Example A (CEA) in Table 4. In some embodiments, a release composition including first and second crosslinkers provides a cured composition with a lower release force than a composition including a crosslinker and a chain extender represented by Formula III-1 even after aging at controlled temperature and humidity (CTH) (i.e., 70° F. (21° C.) and 50% relative humidity) for six or seven days.

The release composition further includes a photoacid generator. Photoacid generators are typically salts that undergo irreversible photodissociation to form an acid upon absorption of light in the ultraviolet and/or visible region of the electromagnetic spectrum. The photoacid generators are typically onium salts. Suitable onium salt photoacid generators useful in practice of the present disclosure are known and are available from commercial suppliers and/or can be prepared by known methods such as those described, for example, in Kirk-Othmer Encyclopedia of Chemical Technology, 4th Edition, Supplement Volume, John Wiley and Sons, New York, 1998, pp. 253-255.

Cations useful as the cationic portion of the onium salt photoacid generators include organic onium cations such as, for example, those described in U.S. Pat. No. 3,708,296 (Schlesinger), U.S. Pat. No. 4,069,055 (Crivello), U.S. Pat. No. 4,216,288 (Crivello), U.S. Pat. No. 4,250,311 (Crivello), U.S. Pat. No. 5,554,664 (Lamanna et al.), and U.S. Pat. No. 4,677,137 (Bany et al.). The cations are typically aliphatic or aromatic I-, S-, P-, and N-centered onium salts. The onium salt photoacid generators typically include sulfoxonium, iodonium, sulfonium, pyridinium, or phosphonium cations.

In many embodiments, the onium salts have cations such as those selected from sulfoxonium, diaryliodonium, triarylsulfonium, diarylalkylsulfonium, dialkylarylsulfonium, and trialkylsulfonium wherein for these compounds the terms “aryl” and “alkyl” mean an unsubstituted or substituted aromatic or aliphatic moiety, respectively, having up to four independently selected substituents. The substituents on the aryl or alkyl moieties will preferably have less than 30 carbon atoms and up to 10 heteroatoms selected from N, S, non-peroxidic O, P, Si, and B. Examples include hydrocarbyl groups such as methyl, ethyl, butyl, dodecyl, tetracosanyl, benzyl, allyl, benzylidene, ethenyl and ethynyl; hydrocarbyloxy groups such as methoxy, butoxy and phenoxy; hydrocarbylmercapto groups such as methylmercapto and phenylmercapto; hydrocarbyloxycarbonyl groups such as methoxycarbonyl and phenoxycarbonyl; hydrocarbylcarbonyl groups such as formyl, acetyl and benzoyl; hydrocarbylcarbonyloxy groups such as acetoxy and cyclohexanecarbonyloxy; hydrocarbylcarbonamido groups such as acetamido and benzamido; azo; boryl; halo groups such as chloro, bromo, iodo and fluoro; hydroxy; carbonyl; trimethylsiloxy; and aromatic groups such as cyclopentadienyl, phenyl, tolyl, naphthyl, and indenyl. With the sulfonium salts, it is possible for the substituent to be further substituted with a dialkyl- or diarylsulfonium cation; an example of this would be 1,4-phenylenebis(diphenylsulfonium).

The anion in the onium salt photoacid generator is selected to provide solubility of the onium salt photoacid generator in organic solvent and compositions, although this is not a requirement. Examples of suitable anions include PF₆⁻, SbF₆⁻, SbF₅OH⁻, Ph₄B⁻, and (PhF₅)₄B⁻ where Ph refers to phenyl.

Some onium salt photoacid generators are diaryliodonium salts, triarylsulfonium salts, and triarylsulfoxonium salts. Specific examples include bis(4-t-butylphenyl)iodonium hexafluoroantimonate (e.g., as available as FP5034 from Hampford Rescarch Inc., Stratford, Connecticut), a mixture of triarylsulfonium salts (diphenyl(4-phenylthio)phenylsulfonium hexafluoroantimonate and bis(4-(diphenylsulfonio)phenyl) sulfide hexafluoroantimonate) (e.g., available as UVI-6976 from Synasia Metuchen, New Jersey), (4-methoxyphenyl)phenyl iodonium triflate, bis(4-tert-butylphenyl)iodonium camphorsulfonate, bis(4-dodecylphenyl)iodonium triflate, bis(4-dodecylphenyl)iodonium hexafluoroantimonate (e.g., available as CAS number 71786-70-4 from various manufacturers), bis(4-tert-butylphenyl)iodonium hexafluorophosphate, bis(4-tert-butylphenyl)iodonium tetraphenylborate, bis(4-tert-butylphenyl)iodonium tosylate, bis(4-tert-butylphenyl)iodonium triflate, ([4-(octyloxy)phenyl]phenyliodonium hexafluorophosphate), ([4-(octyloxy)phenyl]phenyliodonium hexafluoroantimonate), (4-isopropylphenyl)(4-methylphenyl)iodonium tetrakis(pentafluorophenyl)borate (e.g., as available as RHODORSIL 2074 from Bluestar Silicones, East Brunswick, New Jersey), bis(4-methylphenyl)iodonium hexafluorophosphate (e.g., as available as OMNICAT 440 from IGM Resins Bartlett, Illinois), 4-[(2-hydroxy-1-tetradecycloxy)phenyl]phenyliodonium hexafluoroantimonate, triphenylsulfonium hexafluoroantimonate (e.g., as available as CT-548 from Chitec Technology Corp., Taipci, Taiwan), diphenyl(4-phenylthio)phenylsulfonium hexafluorophosphate, bis(4-(diphenylsulfonio)phenyl)sulfide bis(hexafluorophosphate), diphenyl(4-phenylthio)phenylsulfonium hexafluoroantimonate, bis(4-(diphenylsulfonio)phenyl) sulfide hexafluoroantimonate, and blends of these triarylsulfonium salts (e.g., as available from Synasia, Metuchen, New Jersey as UVI-6992 and UVI-6976 for the PF₆⁻ and SbF₆⁻ salts, respectively).

Some examples of onium salt photoacid generators are diaryliodonium salts and triarylsulfonium salts represented by the formulas: (R¹⁵₂I⁺SbF₆⁻, (R¹⁵₂I⁺SbF₅OH⁻, (R¹⁵)₂I⁺B(PhF₅)₄⁻, (R¹⁵)₂I⁺PF₆⁻, (R¹⁵)₃S⁺SbF₆⁻, (R¹⁵)₃S⁺SbF₅OH⁻, (R¹⁵)₃S⁺B(PhF₅)₄⁻, and (R¹⁵)₃S⁺PF₆⁻, and where each R¹⁵ is independently an aryl (e.g., phenyl) or a substituted aryl group (e.g., an aryl substituted with an alkyl such as 4-dodecylphenyl, methylphenyl, and ethylphenyl or an aryl substituted with a —SO₂Ph group such as PhSO₂Ph— where Ph is phenyl) having from 6 to 18 carbon atoms, 6 to 12 carbon atoms, or 6 to 10 carbon atoms. Such materials can be obtained from commercial suppliers and/or synthesized by known methods.

The amount of the photoacid generator is often in a range of 0.25 to 10 weight percent based on the total weight of the release composition. If the amount is too low, the composition will not cure sufficiently, and/or the cure speed will be too slow. If the amount is too high, however, all the photoacid generator may not dissolve in the other components of the release composition. In some embodiments,

the amount is often at least 0.25 weight percent, at least 0.3 weight percent, at least 0.5 weight percent, at least 0.7 weight percent, at least I weight percent, at least 2 weight percent, at least 3 weight percent, or at least 5 weight percent and up to 10 weight percent, up to 8 weight percent, up to 7 weight percent, up to 5 weight percent, up to 3 weight percent, up to 2 weight percent, or up to 1 weight percent based on the total weight of the release composition. The amount can be, for example, in a range of 0.5 to 10 weight percent, 1 to 10 weight percent, 2 to 10 weight percent, 1 to 8 weight percent, or 1 to 5 weight percent based on the total weight of the release composition.

Any of the release compositions can further include an optional silicate resin. The silicate resin can be added to adjust the adhesion of a release layer to (and the case of release of the release layer from) an adjoining adhesive layer. Suitable silicate resins typically contain a combination of structural units selected from structural units M (i.e., monovalent R′₃SiO_{1/2} units), structural units D (i.e., divalent R′₂SiO_{2/2} units), structural units T (i.e., trivalent R′SiO_{3/2} units), and structural units Q (i.e., quaternary SiO_{4/2} units) where R′ refers to a hydrocarbyl, which is usually an aryl (e.g., phenyl) or an alkyl (e.g., methyl). Typical silicate resins include MQ silicate resins, MQD silicate resins, and MQT silicate resins. These silicate resins usually have a number average molecular weight in the range of 100 to 50,000 g/mol, 500 to 15,000 g/mol, or 500 to 10,000 g/mol. Silicate resins can be either nonfunctional or functional silicate resins, the functional resins having one or more reactive groups. Functional groups include, for example, silicon-bonded hydrogen (i.e., silyl hydride groups), silicon-bonded alkenyl (i.e., silyl vinyl groups), and silanol groups. A plurality of silicate resins can be used, if desired.

As shown in Examples 7 to 10, below, the combination of first and second crosslinkers effectively facilitates dissolution of the photoacid generator in release compositions that further contain silicate resins as well as siloxane polymers having a weight average molecular weight that is at least 1000 g/mol. Also as shown in the Examples, below, a release composition including first and second crosslinkers and silicate resins according to the present disclosure provides a cured composition with at least one of lower extractables or a lower initial release force than a composition including a siloxane polymer having a weight average molecular weight that is less than 1000 g/mol. See, for example, Examples 7 to 10 vs. Comparative Example E (CEE) in Table 4.

MQ silicone resins are silicate resins are copolymers having R′₃SiO_{1/2} units (M units) and SiO_{4/2} units (Q units), where R′is an alkyl or aryl group, and most frequently a methyl group. These resins can also have functional groups. Such resins are described in, for example, Encyclopedia of Polymer Science and Engineering, vol. 15, John Wiley & Sons, N.Y., 1989, pp. 265 to 270 and in various patents such as U.S. Pat. No. 2,676,182 (Daudt et al.), U.S. Pat. No. 3,627,851 (Brady), U.S. Pat. No. 3,772,247 (Flannigan), and U.S. Pat. No. 5,248,739 (Schmidt et al.). MQ silicone resins having functional groups are described in U.S. Pat. No. 4,774,310 (Butler), which describes silyl hydride groups, U.S. Pat. No. 5,262,558 (Kobayashi et al.), which describes vinyl and trifluoropropyl groups, and U.S. Pat. No. 4,707,531 (Shirahata), which describes silyl hydride and vinyl groups. The above-described silicate resins are generally prepared in solvent. Dried or solventless MQ silicate resins are prepared as described in U.S. Pat. No. 5,319,040 (Wengrovius et al.), U.S. Pat. No. 5,302,685 (Tsumura et al.), and U.S. Pat. No. 4,935,484 (Wolfgruber et al.).

MQD silicate resins are terpolymers having R′₃SiO_{1/2} units (M units) and SiO_{4/2} units (Q units) and R′₂SiO_{2/2} units (D units) as described, for example, in U.S. Pat. No. 5,110,890 (Butler). MQT silicate resins are terpolymers having R′₃SiO_{1/2} units (M units), SiO_{4/2} units (Q units), and R′SiO_{3/2} units (T units) such as are described in U.S. Pat. No. 5,110,890 (Butler).

Commercially available silicate resins include resins available under the trade designation SR-545, which is a MQ resin in toluene available from Momentive Inc. (Columbus, OH, USA); MQOH resins that are available under the trade designation SQ-299 from Gelest (Morrisville, PA, USA); MQD resin in toluene that is available from Shin-Etsu Chemical Co. Ltd. (Torrance, CA, USA) under the trade designations MQR-32-1, MQR-32-2, and MQR-32-3; and a hydride functional MQ resin in toluene that is available under the trade designation PC-403 from Rhone-Poulenc, Latex and Specialty Polymers (Rock Hill, SC, USA). The silicate resins are often supplied as solutions in an organic solvent. These solutions may be dried, if desired, by any number of techniques known in the art (e.g., spray drying, oven drying, and steam drying) to provide a silicate resin without an organic solvent.

Some release compositions of the present disclosure do not contain a silicate resin while others do. The silicate resin can be used to adjust the strength of adhesion between the release layer and an adjacent adhesive layer. The amount of the silicate resin is often in a range of 0 to 40 weight percent based on the total weight of the release composition. A greater amount of silicate resin tends to increase the force needed to separate the release layer from an adjacent adhesive layer. The amount can be at least 1 weight percent, at least 2 weight percent, at least 3 weight percent, at least 5 weight percent, at least 10 weight percent, at least 15 weight percent and up to 40 weight percent, up to 30 weight percent, up to 25 weight percent, up to 20 weight percent or up to 15 weight percent based on the total weight of the release composition.

The release composition often contains 20 to 95 weight percent siloxane polymer, 1 to 35 weight percent of the first and second crosslinker combined, and 0.25 to 10 weight percent photoacid generator. In some examples, the release composition contains 40 to 85 weight percent siloxane polymer, 5 to 25 weight percent of the first and second crosslinker combined, and 0.5 to 5 weight percent photoacid generator. In still other examples, the release composition contains 50 to 80 weight percent siloxane polymer, 10 to 25 weight percent crosslinker, and 1 to 5 weight percent photoacid generator. In yet other examples, the release composition contains 40 to 85 weight percent siloxane polymer, 8 to 25 weight percent crosslinker, and 1 to 3 weight percent photoacid generator. Any of these compositions can include 0 to 40 weight percent or 0 to 20 weight percent silicate resin based on the total weight of the release composition.

The release composition can be cured by exposure to ultraviolet (UV) or electron beam radiation. In many embodiments, the release composition is cured using ultraviolet radiation. The release composition is often applied to a major surface of a backing layer before curing. Examples of useful UV lights for curing the release composition include high intensity UV lights, such as H-type lamps (commercially available from Fusion UV Curing Systems (Gaithersburg, Maryland, USA)) and medium pressure mercury lamps. When organic solvents are included in the release composition, treatment in a thermal oven may be needed prior to remove the organic solvents before curing with UV radiation. The cured release layer is attached to the backing layer and it not easily separated from the backing layer.

In a second aspect, an article is provided that includes a backing layer having a first major surface and a second major surface opposite the first major surface and a first release layer adjacent to the first major surface of the backing layer. The first release layer comprises a first cured reaction product of a first release composition, wherein the first release composition is the release composition described above in any of its embodiments.

Any suitable backing can be used. In some applications, the backing layer can be constructed of paper, polymeric material, metal, or a combination thereof. The backing layer is usually flexible and is suitable for winding into a roll. The backing can include multiple layers of different materials. In many embodiments the backing layer includes a polymeric film that is prepared from polyester (e.g., polyethylene terephthalate, polybutylene terephthalate, polycaprolactone, and polylactic acid), polyolefin (e.g., polyethylene, polypropylene (e.g., isotactic polypropylene)), polystyrene, polyvinylidene fluoride, polyvinyl alcohol, polyvinyl acetate, ethyl cellulose, cellulose acetate, or copolymers thereof. The thermoplastic films can contain oriented polymeric material in one or two directions such as biaxially oriented polypropylene. Each major surface of the backing layer can be treated, if desired, to enhance chemical and/or physical anchorage of the release layer(s) to the backing layer by application of, for example, primer, corona treatment, flame treatment, or ozone treatment. That is, the release layer is attached (e.g., permanently attached or adhered) to the backing layer and is not easily removed or separated from the backing layer.

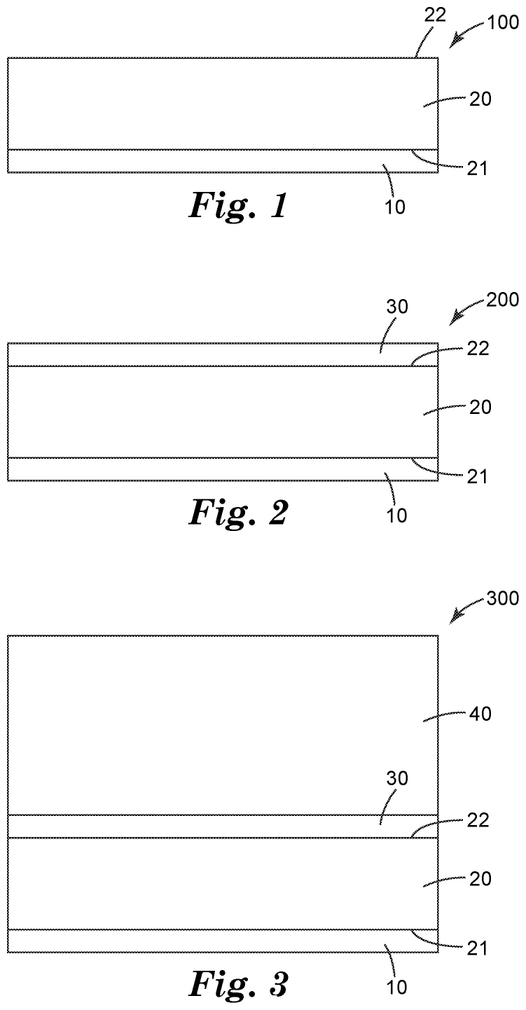

The article or a portion of the article can be as shown in FIG. 1 where the backing layer 20 has a first major surface 21 and a second major surface 22 opposite the first major surface 21. A release layer 10 is positioned adjacent to the first major surface 21 of the backing layer 20 in article 100.

In some embodiments of the article, there is a second release layer positioned adjacent to the second major surface 22 of the backing layer as shown in FIG. 2. Article 200 is arranged in the following order: second release layer 30-backing layer 20-first release layer 10. Such as article can be useful as a release liner in a transfer adhesive tape, for example.

The second release layer comprises a second cured reaction product of a second release composition, wherein the second release composition independently from the first release composition comprises the release composition described above in any of its embodiments. The second release layer can be of a similar composition to the first release layer but may contain more of the silicate resin.

The difference in the silicate resin between the first and second release composition and the resulting first and second release layer can be at least 1 weight percent, at least 2 weight percent, at least 5 weight percent, at least 10 weight percent, at least 15 weight percent, or at least 20 weight percent and up to 40 weight percent, up to 30 weight percent, or up to 20 weight percent. In some embodiments, the first release layer is free of the silicate resin or has less than 1 weight percent silicate resin while the second release layer contains silicate resin. In some embodiments, the amount of the silicate resin in the second release composition and/or second release layer is greater than 1 weight percent, at least 2 weight percent, at least 5 weight percent, at least 10 weight percent, or at least 15 weight percent.

In some embodiments of the article of the present disclosure, an adhesive layer can be positioned adjacent to the second release layer to form, for example, an adhesive transfer tape. Such an article 300 (e.g., adhesive transfer tape) is shown in FIG. 3. Article 300 is arranged in the following order: adhesive layer 40-second release layer 30-backing layer 20-first release layer 10. First release layer 10 is positioned adjacent to the first major surface 21 of the backing layer 20 and the second release layer 30 is positioned adjacent to the second major surface 22 of the backing layer 20. The adhesive layer 40 is positioned adjacent to the second release layer 30 opposite the backing layer 20. If desired, the adhesive layer 40 can be released from (i.e., separated from) the release layer 30. This release occurs such that release layer 30 remains attached to backing layer 20. That is, the second release layer 30 is more strongly attached to the backing layer 20 than to the adhesive layer 40.

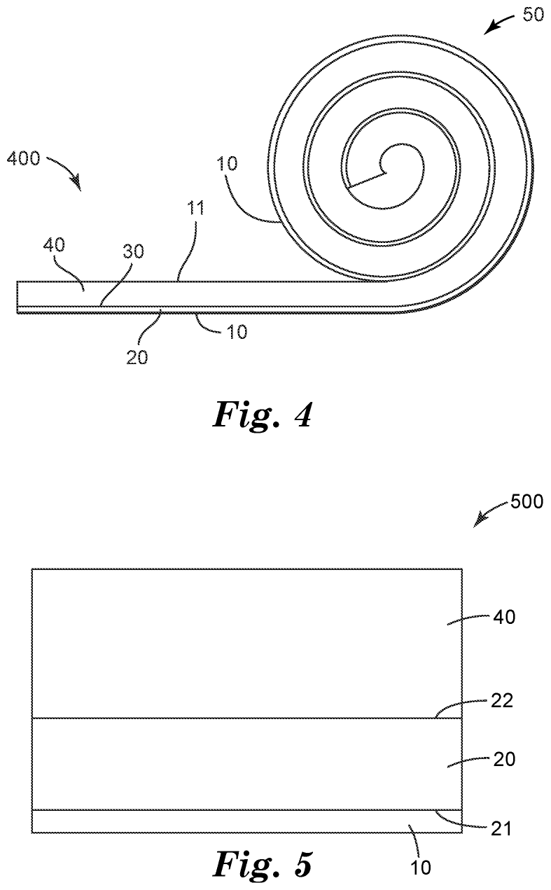

When the article 300 is rolled to form a roll of adhesive transfer tape, the adhesive layer 40 is adjacent to both the second release layer 30 and the first release layer 10. This can be seen in rolled article 400 of FIG. 4. The roll 50 has the first release layer 10 on the outermost surface. The surface 11 of the adhesive layer 40 contacts the first release layer 10 in the roll 50. To unroll the adhesive transfer tape for use, it is desirable that the strength of adhesion of the adhesive layer 40 to the first release layer 10 is less than to the second release layer 30. This can be accomplished by having a greater amount of the silicate resin in the second release layer 30 than in the first release layer 10. After being unrolled, the adhesive layer 40 can be released from the second release layer 30 and applied to another substrate. The release layers 10 and 30 are more strongly attached to the backing layer 20 than to the adhesive layer 40.

In other embodiments, the article can be as shown in FIG. 5. This article 500 includes a first release layer 10, a backing layer 20 with a first major surface 21 adjacent to the backing layer, and an adhesive layer 40 positioned adjacent to a second major surface 22 of the backing layer opposite the first major surface 21. The overall construction is in the following order: first release layer 10-backing layer 20-adhesive layer 40. The adhesive layer 40 is strongly attached (i.e., adhered to the backing layer). If rolled, adhesive layer 40 contacts release layer 10 in the roll (not shown). The release layer 10 is attached more strongly to the backing layer 20 than to the adhesive layer 40. The release layer 10 can be released from the adhesive layer 40 but not the backing layer 20 when the article is unrolled. If desired, other optional layers not shown in FIG. 5 can be included. For example, there can be a primer layer between the backing layer 20 and the adhesive layer 40.

Any suitable adhesive layer 40 can be used. The adhesive can be in the form of a film or foam. In some embodiments, the adhesive layer 40 is a single layer. In other embodiments, the adhesive layer 40 is one layer of a multilayer adhesive construction such as a double-sided adhesive tape. For example, the multilayer adhesive tape can have a first adhesive skin layer, a second adhesive skin layer, and a core layer positioned between the first adhesive skin layer and the second adhesive skin layer. The core layer is often a foam backing layer and can be an adhesive or non-adhesive foam. In another example, the multilayer adhesive tape can have a first adhesive layer, a film backing, and a second adhesive layer. The film backing can be an adhesive or non-adhesive layer.

One class of adhesives that can be included in the adhesive layer 40 are pressure-sensitive adhesives that are based on (meth)acrylate copolymers. The (meth)acrylate copolymers typically have a glass transition temperature (Tg) that is no greater than 20° C., no greater than 10° C., no greater than 0° C., no greater than −10° C., no greater than −20° C., no greater than −30° C., no greater than −40° C., or no greater than −50° C. The glass transition temperature can be measured using techniques such as Differential Scanning calorimetry and Dynamic Mechanical Analysis. Alternatively, the glass transition temperature can be estimated using the Fox equation based on the monomers used to form the adhesive. Lists of glass transition temperatures for homopolymers are available from multiple monomer suppliers such as from BASF Corporation (Houston, TX, USA), Polyscience, Inc. (Warrington, PA, USA), and Aldrich (St. Louis, MO, USA) as well as in various publications such as, for example, Mattioni et al., J. Chem. Inf. Comput. Sci., 2002, 42, 232-240.

The (meth)acrylate copolymers typically are formed from a monomer composition that contains at least one low Tg monomer. As used herein, the term “low Tg monomer” refers to a monomer having a Tg no greater than 20° C. when homopolymerized (i.e., a homopolymer formed from the low Tg monomer has a Tg no greater than 20° C.). Suitable low Tg monomers are often selected from an alkyl (meth)acrylates, heteroalkyl (meth)acrylates, aryl substituted alkyl acrylate, and aryloxy substituted alkyl acrylates.

Examples of low Tg alkyl (meth)acrylate monomers often are non-tertiary alkyl acrylates but can be alkyl methacrylates having a linear alkyl group with at least 4 carbon atoms. Specific examples of alkyl (meth)acrylates include n-butyl acrylate, n-butyl methacrylate, isobutyl acrylate, sec-butyl acrylate, n-pentyl acrylate, 2-methylbutyl acrylate, n-hexyl acrylate, cyclohexyl acrylate, 4-methyl-2-pentyl acrylate, 2-methylhexyl acrylate, 2-ethylhexyl acrylate, n-octyl acrylate, 2-octyl acrylate, isooctyl acrylate, isononyl acrylate, isoamyl acrylate, n-decyl acrylate, isodecyl acrylate, n-decyl methacrylate, lauryl acrylate, isotridecyl acrylate, n-octadecyl acrylate, isostearyl acrylate, and n-dodecyl methacrylate. Isomers and mixture of isomers of these monomers can be used.

Examples of low Tg heteroalkyl (meth)acrylate monomers often have at least 3 carbon atoms, at least 4 carbon atoms, or at least 6 carbon atoms and can have up to 30 or more carbon atoms, up to 20carbon atoms, up to 18 carbon atoms, up to 16 carbon atoms, up to 12 carbon atoms, or up to 10 carbon atoms. Specific examples of heteroalkyl (meth)acrylates include 2-ethoxyethyl acrylate, 2-(2-ethoxyethoxy) ethyl acrylate, 2-methoxyethyl (meth)acrylate, and tetrahydrofurfuryl (meth)acrylate.

Examples of low Tg aryl substituted alkyl acrylates or aryloxy substituted alkyl acrylates include 2-biphenylhexyl acrylate, benzyl acrylate, 2-phenoxyethyl acrylate, and 2-phenylethyl acrylate.

Some monomer compositions for (meth)acrylate copolymers can include an optional polar monomer. The polar monomer has an ethylenically unsaturated group and a polar group such as an acidic group or a salt thereof, a hydroxyl group, a primary amido group, a secondary amido group, a tertiary amido group, or an amino group. Having a polar monomer often facilitates adherence of the pressure-sensitive adhesive to a variety of substrates.

Examples of polar monomers with an acidic group include ethylenically unsaturated carboxylic acids, ethylenically unsaturated sulfonic acids, ethylenically unsaturated phosphonic acids, and mixtures thereof. Examples of such compounds include acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinyl phosphonic acid, and mixtures thereof. Due to their availability, the acid monomer is often acrylic acid or methacrylic acid.

Examples of polar monomers with a hydroxyl group include hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide or 3-hydroxypropyl (meth)acrylamide), ethoxylated hydroxyethyl (meth)acrylate (e.g., monomers commercially available from Sartomer (Exton, PA, USA) under the trade designation CD570, CD571, and CD572), and aryloxy substituted hydroxyalkyl (meth)acrylates (e.g., 2-hydroxy-2-phenoxypropyl (meth)acrylate).

Examples of polar monomers with a primary amido group include (meth)acrylamide. Examples of polar monomers with secondary amido groups include N-alkyl (meth)acrylamides such as N-methyl (meth)acrylamide, N-ethyl (meth)acrylamide, N-isopropyl (meth)acrylamide, N-tert-octyl (meth)acrylamide, and N-octyl (meth)acrylamide.

Examples of polar monomers with a tertiary amido group include N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-dicthylaminopropyl (meth)acrylamide.

A monomer composition for (meth)acrylate copolymers can optionally include a high Tg monomer. As used herein, the term “high Tg monomer” refers to a monomer that has a Tg greater than 30° C., greater than 40° C., or greater than 50° C., when homopolymerized (i.e., a homopolymer formed from the monomer has a Tg greater than 30° C., greater than 40° C., or greater than 50° C.). Some suitable high Tg monomers have a single (meth)acryloyl group such as methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, phenyl acrylate, benzyl methacrylate, 3,3,5 trimethylcyclohexyl (meth)acrylate, 2-phenoxyethyl methacrylate, N-octyl (meth)acrylamide, and mixtures thereof. Other suitable high Tg monomers have a single vinyl group that is not a (meth)acryloyl group such as, for example, various vinyl ethers (e.g., vinyl methyl ether), vinyl esters (e.g., vinyl acetate and vinyl propionate), styrene, substituted styrene (e.g., α-methyl styrene), vinyl halide, and mixtures thereof. Vinyl monomers having a group characteristic of polar monomers are considered herein to be polar monomers.

Still further, the monomer composition for (meth)acrylate copolymers can optionally include a vinyl monomer (i.e., a monomer with an ethylenically unsaturated group that is not a (meth)acryloyl group). Examples of optional vinyl monomers include various vinyl ethers (e.g., vinyl methyl ether), vinyl esters (e.g., vinyl acetate and vinyl propionate), styrene, substituted styrene (e.g., α-methyl styrene), vinyl halide, and mixtures thereof. Vinyl monomers having a group characteristic of polar monomers are considered herein to be polar monomers.

Overall, the pressure-sensitive adhesive can contain up to 100 weight percent (e.g., 100 weight percent) low Tg monomer units. The weight percent value is based on the total weight of monomeric units in the polymeric material. In some embodiments, the (meth)acrylate polymer contains 40 to 100 weight percent of the low Tg monomeric units, 0 to 15 weight percent polar monomeric units, 0 to 50 weight percent high Tg monomeric units, and 0 to 15 weight percent vinyl monomeric units. In some embodiments, the (meth)acrylate polymer contains 60 to 100 weight percent of the low Tg monomeric units, 0 to 10 weight percent polar monomeric units, 0 to 40 weight percent high Tg monomeric units, and 0 to 10 weight percent vinyl monomeric units. In some embodiments, the (meth)acrylate polymer contains 75 to 100 weight percent of the low Tg monomeric units, 0 to 10 weight percent polar monomeric units, 0 to 25 weight percent high Tg monomeric units, and 0 to 5 weight percent vinyl monomeric units.

Other examples of polymers useful in the adhesive layer 40 include semi-crystalline polymer resins, such as polyolefins and polyolefin copolymers (e.g., polymer resins based upon monomers having between 2 and 8 carbon atoms, such as low-density polyethylene, high-density polyethylene, polypropylene, and ethylene-propylene copolymers); polyesters and co-polyesters; polyamides and co-polyamides; fluorinated homopolymers and copolymers; polyalkylene oxides (e.g., polyethylene oxide and polypropylene oxide); polyvinyl alcohol; ionomers (e.g., ethylene-methacrylic acid copolymers neutralized with a base); and cellulose acetate. Further examples of polymers useful in adhesive layer 40 include amorphous polymers such as polyacrylonitrile polyvinyl chloride, thermoplastic polyurethanes, aromatic epoxies, polycarbonates, amorphous polyesters, amorphous polyamides, ABS block copolymers, polyphenylene oxide alloys, ionomers (e.g., ethylene-methacrylic acid copolymers neutralized as salts), fluorinated elastomers, and polydimethyl siloxane.

Another class of polymers useful in the adhesive layer 40 includes elastomers such as polybutadiene, polyisoprene, polychloroprene, random and block copolymers of styrene and dienes (e.g., SBR), and ethylene-propylene-diene monomer rubber. This class of polymer is typically combined with tackifying resins.

In some embodiments, the adhesives of this class are like those described, for example, in U.S. Pat. No. 9,556,367 (Waid et al.). The adhesive is a pressure-sensitive adhesive and contains 92 to 99.9 parts of a block copolymer adhesive composition and 0.1 to less than 10 parts of an acrylic adhesive composition. The block copolymer adhesive composition comprises a first block copolymer comprising at least one rubbery block comprising a first polymerized conjugated diene, a hydrogenated derivative thereof, or combinations thereof and at least one glassy block comprising a first polymerized mono-vinyl aromatic monomer. The acrylic adhesive composition comprises 70 to 100 parts of at least one acrylic or methacrylic ester of a non-tertiary alkyl alcohol, wherein the non-tertiary alkyl alcohol contains 4 to 20 carbon atoms; and 0 to 30 parts of a copolymerized reinforcing monomer.

In some embodiments, the first block copolymer is a multi-arm block copolymer of the formula Qₙ—Y, wherein Q represents an arm of the multi-arm block copolymer, n represents the number of arms and is a whole number of at least 3, and Y is the residue of a multifunctional coupling agent. Each arm, Q, independently has the formula R—G where R represents the rubbery block and G represents the glassy block. In some embodiments, the first block copolymer is a polymodal, asymmetric star block copolymer.

In some embodiments, the pressure sensitive adhesive further comprises a second block copolymer. The second block copolymer contains at least one rubbery block and at least one glassy block. The rubbery block comprises a polymerized second conjugated diene, a hydrogenated derivative thereof, or combinations thereof and the glassy block comprises a second polymerized mono-vinyl aromatic monomer. In some embodiments, the second block copolymer is a linear block copolymer.

The pressure sensitive adhesive further comprises a first high Tg tackifier having a Tg of at least 60° C., wherein the first high Tg tackifier is compatible with at least one rubbery block. In some embodiments, the block copolymer adhesive composition further comprises a second high Tg tackifier having a Tg of at least 60° C., wherein the second high Tg tackifier is compatible with the at least one glassy block.

Further examples of adhesives useful in the adhesive layer 40 includes pressure-sensitive and hot melt applied adhesives including polymers prepared from non-photopolymerizable monomers. Such polymers can be adhesive polymers (i.e., polymers that are inherently adhesive), or polymers that are not inherently adhesive but can form adhesive compositions when compounded with components such as plasticizers and/or tackifiers. Specific examples include poly-alpha-olefins (e.g., polyoctene, polyhexene, and atactic polypropylene), block copolymer-based adhesives, natural and synthetic rubbers, silicone adhesives, ethylene-vinyl acetate, and epoxy-containing structural adhesive blends (e.g., epoxy-acrylate and epoxy-polyester blends).

The adhesive layer 40 may optionally contain other components such as fillers, antioxidants, viscosity modifiers, pigments, tackifying resins, and fibers. These components can be added to the adhesive layer 40 to the extent that they do not alter the desired properties of the final product. In some embodiments, the adhesive layer includes a pigment. Any compound generally used as a pigment can be utilized provided the desired properties of the final product are not negatively impacted. Examples of pigments include carbon black and titanium dioxide. The amount of pigment also depends on the desired use of the product. Generally, the pigment concentration is at least 0.10 weight percent based on the total weight of the adhesive. The amount can be at least 0.15 weight percent or greater than 0.2 weight percent, at least 0.5 weight percent, or at least 1 weight percent and up to 10 weight percent or higher, up to 5 weight percent, up to 2 weight percent, or up to 1 weight percent based on the total weight of the adhesive. The pigment can give an opaque appearance to the adhesive layer.

The adhesive layer 40, if desired, can be at least partially crosslinked by electron beam (“E-beam”) radiation, although additional crosslinking means (e.g., chemical, heat, gamma radiation, and/or ultraviolet and/or visible radiation) may also be used. Crosslinking can impart more desirable characteristics (e.g., increased strength) to the adhesive layer. Electron beam radiation is advantageous because it can crosslink (i.e., cure) adhesive layers that contain pigments or filler and adhesive layers that are relatively thick.

E-Beam radiation causes crosslinking of the adhesive layer by initiating a free-radical chain reaction. Ionizing particulate radiation from the E-Beam is absorbed directly in the polymer and generates free radicals that initiate the crosslinking process. Generally, electron energies of at least about 100 kiloelectron volts (keV) are necessary to break chemical bonds and ionize, or excite, components of the polymer system. The scattered electrons that are produced lead to a large population of free radicals dispersed throughout the adhesive. These free radicals initiate crosslinking reactions (e.g., free-radical polymerization, radical-radical coupling), which results in a three-dimensionally crosslinked polymer.

An electron beam processing unit is useful for supplying the radiation for this process. Generally, a processing unit includes a power supply and an E-Beam acceleration tube. The power supply increases and rectifies the current, and the accelerator generates and focuses the E-Beam and controls the scanning. The electron beam may be produced, for example, by energizing a tungsten filament with high voltage. This causes electrons to be produced at high rates. These electrons are then concentrated to form a high energy beam and are accelerated to full velocity inside the electron gun. Electromagnets on the sides of the accelerator tube allow deflection, or scanning, of the beam.

Scanning widths and depths typically vary from about 61 to 183 centimeters (cm) to about 10 to 15 cm, respectively. The scanner opening is covered with a thin metal foil, usually titanium, which allows passage of electrons, but maintains a high vacuum in the processing chamber. Characteristic power, current, and dose rates of accelerators are about 200 to 500 keV, about 25 to 200 milliamps (mA), and about 1 to 10 megarads (Mrads), respectively. To minimize peroxide formation, the process chamber should be kept at as low an oxygen content as is practical, for example, by nitrogen purging, although this is not a requirement.

Advantageously, the adhesive layer can be crosslinked with electron beam radiation while adjacent to a release layer with minimal or no impact on the ability to separate the release layer from the adhesive layer. This contrasts with many known release layers. Adhesive layer 40 in FIG. 3 can be crosslinked while in contact with release layer 30. The electron beam radiation does not significantly alter the ability to remove the adhesive layer 40 from release layer 30 for use as a transfer adhesive. Adhesive layer 40 in FIG. 3 and in FIG. 5 can be crosslinked without negatively impacting the release characteristics of release layer 10. That is, rolls formed from article 300 in FIG. 3 or from article 500 in FIG. 5 can be unrolled readily even after exposure of the release layer 10 to electron beam radiation.

In another aspect, a method of making an article is provided. The method includes providing a backing layer having a first major surface and a second major surface opposite the first major surface. The method further includes applying a first release composition adjacent to the first major surface of the backing layer. The first release composition can be a release composition as described above in any of its embodiments. The method still further includes exposing the first release composition to ultraviolet radiation or electron beam radiation to form a first release layer.

In some embodiments of the method, an adhesive layer is positioned adjacent to the second major surface of the backing layer. A cured adhesive layer is formed by exposing the adhesive layer to electron beam radiation with the electron beam radiation passing through the first release layer and the backing layer before reaching the adhesive layer.

In other embodiments of the method, a second release composition is positioned adjacent to the second major surface of the backing layer. The second release composition can be as described above in any of its embodiments. The method still further includes exposing the second release composition to ultraviolet radiation or electron beam radiation to form a second release layer. In some embodiments, forming a second release layer on the second major surface of the backing layer is carried out after forming the first release layer on the first major surface of the backing layer.

In still other embodiments of the method where there are two release layers, an adhesive layer is positioned adjacent to the second release layer opposite the backing layer. The method can further include forming a cured adhesive layer by exposing the adhesive layer to electron beam radiation with the electron beam radiation passing through the first release layer, the backing layer, and the second release layer before reaching the curable adhesive layer.

Advantageously, the release characteristics of the first release layer and/or the second release layer towards the cured adhesive layer is not altered significantly be exposure of the release layer(s) to electron beam radiation.

In a first embodiment, the present disclosure provides a release composition comprising:
a siloxane polymer having a weight average molecular weight of at least 1000 grams per mole, the siloxane polymer comprising repeating divalent units represented by formula:

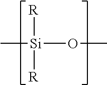

and at least two functional groups selected from the group consisting of silanol, alkoxysilane, —Si(OR²)_{y}(R″)_{3-y}, and a combination thereof,
wherein
each R is independently alkyl,
each R² is independently hydrogen or alkyl;
each R″ is independently alkyl or aryl; and
y is 1, 2, or 3; and
   a first crosslinker and a second crosslinker, each independently a compound represented by formula Si(OR⁵)₄ or R¹Si(OR⁵)₃, or a compound having at least two groups represented by formula —Si(R⁴)ₓ(OR⁵)₃₋ₓ,
wherein
each R⁴ is independently alkyl or aryl;
each R¹ and R⁵ is independently alkyl; and
x is 0 or 1; and
   a photoacid generator.

In a second embodiment, the present disclosure provides the release composition of the first embodiment having less than one percent by weight, based on the total weight of the release composition, of a silane additive having two silyl groups of formula —Si(R⁶)₂(OR⁷) or having a single silyl group of formula —Si(R¹⁰)(OR⁹)₂, wherein
each R⁶ and R¹⁰ is independently alkyl or aryl; and
each R⁷ and R⁹ is independently alkyl.

In a third embodiment, the present disclosure provides the release composition of the first or second embodiment, wherein the siloxane polymer comprises terminal units represented by formula —Q—Si(OR²)_{y}(R″)_{3-y}, divalent units represented by formula:

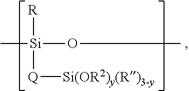

or divalent units represented by formula

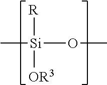

wherein
each R is independently alkyl,
each R² is independently hydrogen or alkyl;
each R″ is independently alkyl or aryl;
each R³ is independently hydrogen or alkyl;
y is 1, 2, or 3; and
each Q is independently alkylene, arylene, or alkylene that is at least one of interrupted or terminated by aryl, each optionally at least one of interrupted or terminated by at least one ether, thioether, amine, amide, ester, thioester, carbonate, thiocarbonate, carbamate, thiocarbamate, urea, thiourea, or a combination thereof.

In a fourth embodiment, the present disclosure provides the release composition of any one of the first to third embodiments, wherein the siloxane polymer is represented by formula

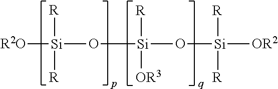

wherein
each R is independently alkyl,
each R² is independently hydrogen or alkyl;
each R³ is independently hydrogen or alkyl; and
p is at least 10; and
q is in a range of 0 to 0.1(p).

In a fifth embodiment, the present disclosure provides the release composition the fourth embodiment, wherein p is in a range of 10 to 1000, and q is in a range from 0 to 100.

In a sixth embodiment, the present disclosure provides the release composition of any one of the first to fifth embodiments, wherein the siloxane polymer comprises at least two of the siloxane polymers.

In a seventh embodiment, the present disclosure provides the release composition of any one of the first to sixth embodiments, wherein the siloxane polymer has a weight average molecular weight in a range of 1000 to 50,000 grams per mole.

In an eighth embodiment, the present disclosure provides the release composition of any one of the first to seventh embodiments, wherein the first and second crosslinker are each independently represented by formula

(OR⁵)₃₋ₓ(R⁴)ₓSi—R⁸—Si(R⁴)ₓ(OR⁵)₃₋ₓ
wherein R⁸ is oxy, a group of formula —O—[Si(CH₃)₂—O]ₘ—, an alkylene, an alkylene—Si(CH₃)₂—O—Si(CH₃)₂-alkylene, a heteroalkylene, a heteroarylene substituted with a hydroxyl group, an arylene, a fluorine substituted arylene, or an alkylene-arylene-alkylene group, m is in a range of 1 to 10, R⁴ is alkyl or aryl, R⁵ is alkyl, and x is 0 or 1.

In a ninth embodiment, the present disclosure provides the release composition of the eighth embodiment, wherein for at least one of the first or second crosslinker, R₈ is oxy, a group of formula —O—[Si(CH₃)₂—O]ₘ—, an alkylene, or an alkylene—Si(CH₃)₂—O—Si(CH₃)₂-alkylene, wherein each alkylene independently has up to four carbon atoms.

In a tenth embodiment, the present disclosure provides the release composition of the eighth or ninth embodiment, wherein the first crosslinker is represented by formula (OR⁵)₃₋ₓ(R⁴)ₓSi—R⁸—Si(R⁴)ₓ(OR⁵)₃₋ₓ, and wherein the second crosslinker is represented by formula Si(OR⁵)₄.

In an eleventh embodiment, the present disclosure provides the release composition of any one of the first to tenth embodiments, wherein at least one of the first or second crosslinkers is represented by formula Si(OR⁵)₄ or R¹Si(OR⁵)₃, where R¹ and R⁵ are each independently alkyl.

In a twelfth embodiment, the present disclosure provides the release composition of any one of the first to eleventh embodiments, wherein the photoacid generator is a diaryliodonium salt or a triarylsulfonium salt, wherein any aryl group is optionally substituted with an alkyl group.

In a thirteenth embodiment, the present disclosure provides the release composition of the twelfth embodiments, wherein the anion of the diaryliodonium salt of the triarylsulfonium salt is selected from PF₆⁻, SbF₆⁻, SbF₅OH⁻, Ph₄B⁻, and (PhF₅)₄B⁻ where Ph refers to phenyl.

In a fourteenth embodiment, the present disclosure provides the release composition of any one of the first to thirteenth embodiments, further comprising a silicate resin.

In a fifteenth embodiment, the present disclosure provides the release composition of the fourteenth embodiment, wherein the silicate resin is an MQ silicate resin, MQD silicate resin, MDT silicate resin, or a mixture thereof.

In a sixteenth embodiment, the present disclosure provides the release composition of any one of the first to fifteenth embodiments, wherein the release composition comprises 0 to 40 weight percent or 0 to 20 weight percent silicate resin based on the total weight of the release composition.

In a seventeenth embodiment, the present disclosure provides the release composition of any one of the first to sixteenth embodiments, wherein the release composition contains 20 to 95 weight percent of the siloxane polymer, 1 to 35 weight percent of the first and second crosslinker combined, 0.25 to 10 weight percent photoacid generator, and 0 to 40 weight percent of a silicate resin.

In an eighteenth embodiment, the present disclosure provides the release composition of any one of the first to seventeenth embodiments, wherein the release composition contains 40 to 85 weight percent of the siloxane polymer, 5 to 25 weight percent of the first and second crosslinker combined, 0.5 to 5 weight percent photoacid generator, and 0 to 40 weight percent of a silicate resin.

In a nineteenth embodiment, the present disclosure provides the release composition of any one of the first to eighteenth embodiments, wherein the release composition is cured by exposure to ultraviolet radiation or electron beam radiation.

In a twentieth embodiment, the present disclosure provides an article that includes:
a backing layer having a first major surface and a second major surface opposite the first major surface; and
a first release layer adjacent to the first major surface of the backing layer. The first release layer comprises a first cured reaction product of a first release composition, wherein the first release composition comprises the release composition of any one of the first to nineteenth embodiments.

In a twenty-first embodiment, the present disclosure provides the article of the twentieth embodiment, further comprising an adhesive layer adjacent to the second major surface of the backing layer.

In a twenty-second embodiment, the present disclosure provides the article of the twentieth or twenty-first embodiment, further comprising a second release layer adjacent to the second major surface of the backing layer wherein the second release layer comprises a second cured reaction product of a second release composition. The second release composition independently from the first release composition comprises the release composition of any one of the first to nineteenth embodiments.

In a twenty-third embodiment, the present disclosure provides the article of the twenty-second embodiment, further comprising an adhesive layer adjacent to the second release layer opposite the backing layer.

In a twenty-fourth embodiment, the present disclosure provides the article of the twenty-first or twenty-third embodiment, wherein the adhesive layer is a first layer of a multilayer adhesive.

In a twenty-fifth embodiment, the present disclosure provides the article of the twenty-fourth embodiment, wherein the multilayer adhesive comprises the first layer as an adhesive skin layer, a core layer, and a second adhesive skin layer with the core layer positioned between the first adhesive skin layer and the second adhesive skin layer.

In a twenty-sixth embodiment, the present disclosure provides the article of the twenty-fifth embodiment, wherein the core of the multilayer adhesive is a foam.

In a twenty-seventh embodiment, the present disclosure provides the article of any one of the twentieth to twenty-sixth embodiments, wherein the article has not more than three percent extractables as measured by the Silicone Extractable Procedure.

In a twenty-eighth embodiment, the present disclosure provides a process for making an article. The process includes applying a first release composition adjacent to a first major surface of a backing layer. The backing layer further comprises a second major surface opposite the first major surface. The first release composition comprises the release composition of any one of the first to nineteenth embodiments. The process still further includes exposing the first release composition to ultraviolet radiation or electron beam radiation to form a first release layer.

In a twenty-ninth embodiment, the present disclosure provides the process of the twenty-eighth embodiment, further comprising positioning a curable adhesive layer adjacent to a second major surface of the backing layer.

In a thirtieth embodiment, the present disclosure provides the process of the twenty-ninth embodiment, further comprising forming a cured adhesive layer by exposing the curable adhesive layer to electron beam radiation with the electron beam radiation passing through the first release layer and the backing layer before reaching the curable adhesive layer.

In a thirty-first embodiment, the present disclosure provides the process of the twenty-eighth embodiment, further comprising applying a second release composition adjacent to the second major surface of the backing layer, wherein the second release composition independently from the first release composition comprises the release composition of any one of the first to nineteenth embodiments.

In a thirty-second embodiment, the present disclosure provides the process of the thirty-first embodiment, further comprising positioning a curable adhesive layer adjacent to the second release layer opposite the backing layer.

In a thirty-third embodiment, the present disclosure provides the process of the thirty-second embodiment, further comprising forming a cured adhesive layer by exposing the curable adhesive layer to electron beam radiation with the electron beam radiation passing through the first release layer, the backing layer, and the second release layer before reaching the curable adhesive layer.

### EXAMPLES

Unless otherwise noted, all parts, percentages, ratios, etc, in the Examples and the rest of the specification are by weight. Weight percent is abbreviated wt-%.

TABLE 1
Materials List

| Material | Description | Source |
|---|---|---|
| Material 1 | 1,3-diethoxytetramethyldi- | Gelest Incorporated |
| | siloxane | Morrisville, PA, USA |
| Material 2 | 1,3-bis(triethoxysilylethyl)tetra- | Gelest Incorporated |
| | methyldisiloxane | |
| Material 3 | 1,1,3,3-tetraethoxy-1,3- | Gelest Incorporated |
| | dimethyldisiloxane | |
| Material 4 | Bis(triethoxysilyl)methane | Gelest Incorporated |
| Material 5 | Tetraethoxysilane, available | Dow Corning |
| | under the trade designation | Corporation, |
| | XIAMETER OFS-06697 Silane | Midland, MI, USA |
| Material 6 | Siloxane compound containing | Dow Corning |
| | an alkyl group and alkoxy group, | |
| | available under the trade | Corporation |
| | designation DOWSIL 11-100, | |
| | includes 20% to 30% by weight | |
| | trimethoxypropylsilane | |
| | crosslinker | |
| Material 7 | 1,8-bis(triethoxysilyl)octane | Gelest Incorporated |
| DMS-S12 | A siloxane polymer that is a | Gelest Incorporated |
| | silanol terminated poly- | |
| | dimethylsiloxane with | |
| | molecular weight of about | |
| | 700 grams/mole available under | |
| | the designation DMS-S12 Y01 | |
| PMX-0930 | A siloxane polymer that is a | Dow Corning |
| | silanol terminated poly- | Corporation |
| | dimethylsiloxane with a | |
| | molecular weight of 2400 | |
| | g/mole, available under | |
| | the trade designation | |
| | XIAMETER PMX-0930 | |
| MQ1600 | 100% trimethylsiloxysilicate | Dow Corning |
| | resin available under the | Corporation |
| | trade designatin DOWSIL | |
| | MQ-1600 Solid Resin | |
| SQO-299 | Silanol-trimethylsilyl modified | Gelest Incorporated |
| | Q resin available under | |
| | the designation SQO-299 | |
| SQX1 | Silicate material available | Momentive |
| | under the trade designation | Performance |
| | INDUSIL SQX1 Silicone | Materials, Waterford, |
| | | NY, USA |
| PAG | Bis(dodecylphenyl) iodonium | 3M Company, |
| | hexafluoroantimonate | St. Paul, |
| | | MN, USA |
| Mixture 1 | A mixture of 80 wt-% Material 7 | |
| | and 20 wt-% PAG | |
| Mixture 2 | A mixture of 65 wt-% DMS-S12 | |
| | and 35 wt-% SQO-299 | |
| Mixture 3 | A mixture of 65 wt-% Material 5 | |
| | and 35 wt-% SQO-299 | |
| Mixture 4 | A mixture of 65 wt-% Material 5 | |
| | and 35 wt-% SQX1 | |
| Mixture 5 | A mixture of 65 wt-% Material 5 | |
| | and 35 wt-% MQ1600 | |

### Test Methods

### Silicone Coat Weight Procedure

Silicone coat weights were determined by comparing approximately 3.69-centimeter (cm) diameter samples of coated and uncoated substrates using an XRF analyzer (obtained from Oxford Instruments (Elk Grove Village, IL, USA) under trade designation OXFORD LAB X3000).

Silicone Extractable Procedure

Unreacted silicone extractables were measured on cured thin film formulations to ascertain the extent of silicone crosslinking. The percent extractable silicone (i.e., the unreacted silicone extractables), a measure of the extent of silicone cure on a release liner, was measured by the following method. The silicone coat weight of a 3.69 cm diameter sample of coated substrate was determined according to the Silicone Coat Weight Procedure identified above. The coated substrate sample was then immersed in and shaken with methyl isobutyl ketone (MIBK) for 5.0 minutes, removed, and allowed to dry. The silicone coating weight was measured again according to the Silicone Coat Weight Procedure. Silicone extractables were attributed to the weight difference between the silicone coat weight before and after extraction with MIBK as a percent using the following formula.

[(a−b)/a]*100=Percent Extractable Silicone

In this formula, the variable a refers to the initial coating weight (before extraction with MIBK) and variable b refers to the final coating weight (after extraction with MIBK).

### Release Force

The 180° angle release force of a release liner to an adhesive sample was measured in the following manner. Acrylic Plus Tape EX4511 or EX4311 (both from 3M Company of St. Paul, MN, United States) were applied to release liner constructions with the first skin adhesive of the tape in contact with the silicone coated surface of the release liner. The resulting laminates were then rolled-over using a 2.0-kilogram (4.5-pound) rubber roller one time in each direction and aged for 7 days at 23° C. at 50% RH or 158° F. (70° C.) at 50% RH prior to testing for release adhesion strength.

Next, a double-sided foam tape (3M Double Coated Urethane Foam Tape 4008, a 0.125-inch-thick open-cell, flexible urethane foam tape, available from 3M Company, Maplewood, MN) was applied to the platen of a peel tester (Slip/Peel Tester, Model 3M90, available from Instrumentors, Incorporated, Strongsville, OH). A sample of the release liner/tape laminate, measuring 2.54 centimeters by approximately 20 centimeters (1 inch by 8 inches), was then applied to the exposed foam tape surface such that the exposed surface of the tape contacted the foam tape. This was rubbed down using light thumb pressure followed by rolling over it with a 2.0-kilogram (4.5-pound) rubber roller one time in each direction. The tape was then removed from the liner at an angle of 180° at a rate of 229 centimeters/minute (90 inches/minute). Results were obtained in grams/inch and converted to Newtons/meter (N/m). Three to five laminates were evaluated and the average release adhesion strength of the total number of laminates tested was reported. Testing was performed initially after sample assembly, at controlled temperature and humidity (CTH) (i.e., 70° F. (21° C.) and 50% RH), and at 158° F. (70° C.) after a time interval lapsed (e.g., six or seven days). Release force results for samples are summarized in Table 4.

### Method of Determining Molecular Weight

Molecular weights were determined at 23° C. by gel permeation chromatography (GPC) using a Model AGILENT 1100 Series LC SYSTEM (Agilent Technologies, Santa Clara, CA) equipped with a JORDI Gel DVB (Divinyl Benzene) MB-LS (Mixed Bed-Light Scattering) 250 millimeter (length)×10 millimeter I.D. (Inside Diameter) column set, in combination with a Model WYATT REX DIFFERENTIAL REFRACTIVE INDEX DETECTOR and a Model WYATT HELEOS II 18 ANGLE STATIC LIGHT SCATTERING DETECTOR (Wyatt Technology Corporation, Santa Barbara, CA). Polymer sample solutions were prepared by adding 10 milliliters of tetrahydrofuran (THF) to a sample weighing approximately 50 to 100 milligrams and mixing for at least 14 hours followed by filtering through a 0.2 micrometer polytetrafluoroethylene syringe filter. The injection volume was 60 microliters, and the THF eluent flow rate was 1.0 milliliter/minute. Duplicate solutions were run. The results were analyzed using Wyatt ASTRA software, Version 5.3.

### Method of Determining Volatile Content in Polymers

Typically, 50.0 grams of polymer is kept in an aluminum tray of the following dimension: (14×12×6 cm) at 150° C. in open air under the fume-hood for one hour. The weight percent volatile content was calculated by the following formula and reported in Table 2.

(x−y)/x*100=weight percentage volatiles

In this formula, the variable x is equal to the initial weight of polymer (before heating) and the variable y is equal to the final weight of polymer (after heating for one hour).

TABLE 2
Weight percentage volatiles in DMS-S12 Y01 and PMX-0930

| | Average Molecular Weight (Mw), | wt-% |
|---|---|---|
| Polymer | g/mole | volatile |
| DMS-S12 Y01 | 700 | 84.2% |
| PMX-0930 | 2400 | 32.4% |

### Adhesive Lamination and E-Beam Process

The following comparative examples (CE) and examples (EX) were prepared to evaluate the release force characteristics under conditions that would be used in the manufacturing process of transfer trapes and/or regular adhesive tapes. The examples simulate and evaluate the release characteristics of the release layer adjacent to the adhesive layer after E-Beam exposure.

A method was used to evaluate the effect of E-Beam radiation having a dosage of 8 to 12Megarads (Mrads) and an accelerating voltage of 275 kiloelectron volts (keV) on liner release forces. An Energy Sciences Inc. (ESI) ELECTROCURTAIN CB-300 E-Beam unit (Wilmington, MA, USA) was used to treat the samples. Laminate samples of the adhesive tape with one side were prepared and tested under the following condition: the coated side of the test liner was E-Beam treated. Then, the E-Beam treated side of the test liner was immediately laminated to the adhesive side of Acrylic Plus Tape EX4511 (3M Company) using a 4.5 lbs. (2.0 kg) roller.

### Examples 1 to 10 (EX1-EX10) and Comparative Examples A to E (CEA-CEE)

Materials listed in Table 3 excluding heptane and MEK were combined in a glass vial. Each formed a transparent solution with no precipitate. The solutions were allowed to stand for 24 hours, and they remained transparent with no precipitate.

For convenience of coating in a laboratory setting, solutions including solvent were then prepared. Materials listed in Table 3 were added to a 50-milliliter glass vial and mixed. The experimental silicone release liners were coated out of solvent onto a corona treated 0.11 mm (4.5 mil) thick polyethylene film (180 mJ/cm²), using a Mayer Rod. The choice of Mayer rod and % solids of the coating solution determined the coat weight (in grams per square meter (gsm)). The silicone coating was then passed through an H-bulb fusion UV processor (24 ft/min, 2 passes, 40% power to obtain 25 mJ/cm² UVC per pass). The samples underwent Release Force testing, and results are represented in Table 4.

For Comparative Example C (CEC), a mixture of 4.4 g PMX-0930 and 0.6 g of Mixture 1 was cloudy and included a solid precipitate. This mixture would not cure when exposed to UV radiation.

For Comparative Example D (CED), a mixture of 3.4 g PMX-0930, 0.86 g Mixture 2, 0.18 g Material 5, and 0.57 g Mixture I was cloudy and included a solid precipitate.

For EX7-EX10 and CEE, Release Force testing occurred after the Adhesive Lamination and E-Beam Process above with the exception that the sample adhesive was laminated directly to the test liner and E-beamed at 12 Mrads with a 250 KeV accelerating voltage. The samples were then aged and tested.

TABLE 3
Formulations (quantities in grams)

| | | | | | Mixture | Mixture | Mixture | Mixture | Mixture | | |
|---|---|---|---|---|---|---|---|---|---|---|---|
| | Material | Material | DMS-S12 | PMX-0931 | 1 | 2 | 3 | 4 | 5 | Heptane | MEK |
| | # | (g) | (g) | (g) | (g) | (g) | (g) | (g) | (g) | (g) | (g) |
| CEA | 1 | 2.63 | 0 | 6.15 | 1.2 | 0 | 0 | 0 | 0 | 11.98 | 2.99 |
| EX1 | 2 | 1.76 | 0 | 7.02 | 1.2 | 0 | 0 | 0 | 0 | 11.98 | 2.99 |
| EX2 | 3 | 1.76 | 0 | 7.02 | 1.2 | 0 | 0 | 0 | 0 | 11.98 | 2.99 |
| EX3 | 4 | 1.76 | 0 | 7.02 | 1.2 | 0 | 0 | 0 | 0 | 11.98 | 2.99 |
| EX4 | 5 | 1.32 | 0 | 7.46 | 1.2 | 0 | 0 | 0 | 0 | 11.98 | 2.99 |
| EX5 | 6 | 2.20 | 0 | 6.56 | 1.2 | 0 | 0 | 0 | 0 | 11.98 | 2.99 |
| EX6 | 6 | 0.88 | 0 | 2.63 | 0.45 | 0 | 0 | 0 | 0 | 4.76 | 1.19 |
| CEB | | 0 | 3.51 | 0 | 0.49 | 0 | 0 | 0 | 0 | 4.80 | 1.20 |
| EX7 | 5 | 0.18 | 0 | 3.4 | 0.57 | 0 | 0.86 | 0 | 0 | 9.33 | 2.33 |
| EX8 | 5 | 0.18 | 0 | 3.4 | 0.57 | 0 | 0 | 0.86 | 0 | 9.33 | 2.33 |
| EX9 | 5 | 0.18 | 0 | 3.4 | 0.57 | 0 | 0 | 0 | 0.86 | 9.33 | 2.33 |
| EX10 | 5 | 1.07 | 0 | 2.5 | 0.57 | 0.86 | 0 | 0 | 0 | 9.33 | 2.33 |
| CEE | 5 | 0 | 3.63 | 0 | 0.57 | 0.86 | 0 | 0 | 0 | 9.33 | 2.33 |

TABLE 4
Test Results

| | | | Release Force EX4511 | | |
|---|---|---|---|---|---|
| | | | | 7 Day | 7 Day |
| | Coat | Extractables | Initial | CTH | 158° F. |
| | Weight | wt % | g/in | g/in | g/in |
| | (gsm) | (%) | (N/m) | (N/m) | (N/m) |
| CEA | 4.14 | 2.17 | 34.3 | 73.1 | 282.1 |
| | | | (13.2) | (28.2) | (108.9) |
| EX1 | 4.59 | 1.53 | 47.2 | 259.5 | 684.3 |
| | | | (18.2) | (100.2) | (264.2) |
| EX2 | 4.41 | 0.91 | 39.9 | 151.4 | 462.8 |
| | | | (15.4) | (58.5) | (178.7) |
| EX3 | 4.34 | 1.61 | 31.3 | 183.8 | 771.3 |
| | | | (12.1) | (71.0) | (297.8) |
| EX4 | 4.60 | 1.52 | 30.4 | 62.9 | 329.4 |
| | | | (11.7) | (24.3) | (127.2) |
| EX5 | 4.47 | 2.68 | 16.4 | 65.8 | 318.0 |
| | | | (6.3) | (25.4) | (122.8) |
| CEB | 2.45 | 1.91 | *nt | 205 | 637.0 |
| | | | | (79.1) | (245.9) |
| EX6 | 2.68 | 3.12 | *nt | 87.6 | 551.7 |
| | | | | (33.8) | (213.0) |
| EX7 | 1.23 | 2.44 | *nt | 408.9 | 508.3 |
| | | | | (157.9) | (196.3) |
| EX8 | 1.19 | 3.20 | *nt | 322.4 | 542.4 |
| | | | | (124.5) | (209.4) |
| EX9 | 1.30 | 1.54 | *nt | 436.2 | 482.0 |
| | | | | (168.4) | (186.1) |
| EX10 | 1.39 | 2.88 | *nt | 327.4 | 471.9 |
| | | | | (126.4) | (182.2) |
| CEE | 1.22 | 2.46 | *nt | 574.5 | 545.1 |
| | | | | (221.8) | (210.5) |

*nt—indicates not tested

As reported in Int. Pat. Appl. Pub. No. WO 2020/128729 Comparative Example CE2, a mixture of 4.4 g PMX-0930. 0.6 g of Mixture 1, and 0.58 Material 7 was transparent. However, when a 25 wt-% solution of the mixture in heptane/methyl ethyl ketone (80:20 w/w) was coated and cured on a PET film using a method similar to that described in Examples 1 to 6, above, the amount of silicone extractables was measured to be 3.84%. The release force measured after seven days of CTH conditions was 224 g/in (103 N/dm), and after aging at 158° F. (70° C.), the release layer could not be separated from adhesive layer.

The preceding description, given to enable one of ordinary skill in the art to practice the claimed disclosure, is not to be construed as limiting the scope of the disclosure, which is defined by the claims and all equivalents thereto.

1. A release composition comprising:
a siloxane polymer having a weight average molecular weight of at least 1000 grams per mole, the siloxane polymer comprising repeating divalent units represented by formula: 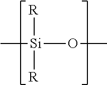
and at least two functional groups selected from the group consisting of silanol, alkoxysilane, —Si(OR²)_{y}(R″)_{3-y}, and a combination thereof,
wherein
each R is independently alkyl,
each R² is independently hydrogen or alkyl;
each R″ is independently alkyl or aryl; and
y is 1, 2, or 3; and
a first crosslinker and a second crosslinker, each independently a compound represented by formula Si(OR⁵)₄ or R¹Si(OR⁵)₃, or a compound having at least two groups represented by formula —Si(R⁴)ₓ(OR⁵)₃₋ₓ,
wherein
each R⁴ is independently alkyl or aryl;
each R¹ and R⁵ is independently alkyl; and
x is 0 or 1; and
a photoacid generator.

2. The release composition of claim 1 having less than one percent by weight, based on the total weight of the release composition, of a silane additive having two silyl groups of formula —Si(R⁶)₂(OR⁷) or having a single silyl group of formula —Si(R¹⁰)(OR⁹)₂, wherein each R⁶ and R¹⁰ is independently alkyl or aryl; and
each R¹ and R⁹ is independently alkyl.

3. The release composition of claim 1, wherein the siloxane polymer comprises terminal units represented by formula —Q—Si(OR²)_{y}(R″)_{3-y}, divalent units represented by formula: 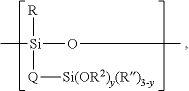
or divalent units represented by formula 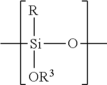
wherein
each R is independently alkyl,
each R² is independently hydrogen or alkyl;
each R″ is independently alkyl or aryl;
each R³ is independently hydrogen or alkyl;
y is 1, 2, or 3; and
each Q is independently alkylene, arylene, or alkylene that is at least one of interrupted or terminated by aryl, each optionally at least one of interrupted or terminated by at least one ether, thioether, amine, amide, ester, thioester, carbonate, thiocarbonate, carbamate, thiocarbamate, urea, thiourea, or a combination thereof.

4. The release composition of claim 1, wherein the siloxane polymer is represented by formula 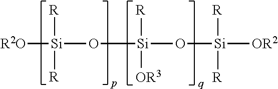
wherein
each R is independently alkyl,
each R² is independently hydrogen or alkyl;
each R³ is independently hydrogen or alkyl; and
p is at least 10; and
q is in a range of 0 to 0.1(p).

5. The release composition of claim 1, wherein the first and second crosslinker are each independently represented by formula
(OR⁵)₃₋ₓ(R⁴)ₓSi—R⁸—Si(R⁴)ₓ(OR⁵)₃₋ₓ
wherein R⁸ is oxy, a group of formula —O—[Si(CH₃)₂—O]ₘ—, an alkylene, an alkylene—Si(CH₃)₂—O—Si(CH₃)₂-alkylene, a heteroalkylene, a heteroarylene substituted with a hydroxyl group, an arylene, a fluorine substituted arylene, or an alkylene-arylene-alkylene group, m is in a range of 1 to 10, R⁴ is alkyl or aryl, R⁵ is alkyl, and x is 0 or 1.

6. The release composition of claim 5, wherein for at least one of the first or second crosslinker, R₈ is oxy, a group of formula —O—[Si(CH₃)₂—O]ₘ—, an alkylene, or an alkylene—Si(CH₃)₂—O—Si(CH₃)₂-alkylene, wherein each alkylene independently has up to four carbon atoms.

7. The release composition of claim 5, wherein the first crosslinker is represented by formula (OR⁵)₃₋ₓ(R⁴)ₓSi—R⁸—Si(R⁴)ₓ(OR⁵)₃₋ₓ, and wherein the second crosslinker is represented by formula Si(OR⁵)₄.

8. The release composition of claim 1, further comprising a silicate resin.

9. The release composition of claim 1, wherein the release composition comprises 20 to 95 weight percent of the siloxane polymer, 1 to 35 weight percent of the first and second crosslinker combined, 0.25 to 10 weight percent of the photoacid generator, and 0 to 40 weight percent of a silicate resin.

10. An article comprising:
a backing layer having a first major surface and a second major surface opposite the first major surface; and
a first release layer adjacent to the first major surface of the backing layer, wherein the first release layer comprises a first cured reaction product of a first release composition wherein the first release composition comprises the release composition of claim 1.

11. The article of claim 10, further comprising a second release layer adjacent to the second major surface of the backing layer wherein the second release layer comprises a second cured reaction product of a second release composition, wherein the second release composition independently from the first release composition comprises the release composition.

12. The article of claim 10, further comprising an adhesive layer on the second major surface of the backing layer.

13. The article of claim 10, wherein the article has not more than three percent extractables as measured by the Silicone Extractable Procedure.

14. A method of making an article, the method comprising:
applying a first release composition adjacent to a first major surface of a backing layer, wherein the backing layer further comprises a second major surface opposite the first major surface, wherein the first release composition comprises the release composition of claim 1; and
exposing the first release composition to ultraviolet radiation or electron beam radiation to form a first release layer.

15. The method of claim 14, further comprising:
applying a second release composition adjacent to the second major surface of the backing layer, wherein the second release composition independently from the first release composition comprises the release composition; and
exposing the second release composition to ultraviolet radiation or electron beam radiation to form a second release layer.

16. The method of claim 14, further comprising:
positioning an adhesive layer on the second major surface of the backing layer; and
exposing the adhesive layer to electron beam radiation.

17. The article of claim 12, wherein the adhesive layer is a first layer of a multilayer adhesive.

18. The article of claim 17, wherein the multilayer adhesive comprises the first layer as an adhesive skin layer, a core layer, and a second adhesive skin layer with the core layer positioned between the first adhesive skin layer and the second adhesive skin layer.

19. The article of claim 18, wherein the core layer of the multilayer adhesive is a foam.

20. The release composition of claim 1, wherein the release composition contains 40 to 85 weight percent of the siloxane polymer, 5 to 25 weight percent of the first and second crosslinker combined, 0.5 to 5 weight percent of the photoacid generator, and 0 to 40 weight percent of a silicate resin.
